(19) United States
(12) Patent Application Publication
(10) Pub. No.: US 2024/0408938 A1
(43) Pub. Date: Dec. 12, 2024

(54) COOLANT-REFRIGERANT HEAT EXCHANGER AND THERMAL MANAGEMENT SYSTEM

(71) Applicant: LITENS AUTOMOTIVE PARTNERSHIP, Woodbridge (CA)

(72) Inventors: Soheil MOHAGHEGHI FARD, Maple (CA); Gianmarc COPPOLA, Concord (CA); Christopher MACPHAIL, Toronto (CA); David NAKHLA, Ancaster (CA)

(21) Appl. No.: 18/702,708

(22) PCT Filed: Oct. 13, 2022
(86) PCT No.: PCT/CA2022/051509

§ 371 Date: Apr. 18, 2024

Related U.S. Application Data
(60) Provisional application No. 63/262,482, filed on Oct. 13, 2021.
(60) Provisional application No. 63/366,861, filed on Jun. 23, 2022.

(51) Int. Cl. B60H 1/00

(52) U.S. Cl. CPC B60H 1/00885; B60H 2001/00307; B60H 2001/00949

(57) ABSTRACT

A thermal management system is provided for an electric vehicle. The thermal management system includes a refrigerant system, a coolant system, a plurality of thermal loads, and a coolant-refrigerant heat exchanger, that includes a secondary heater positioned to heat both the refrigerant and the coolant in the coolant-refrigerant heat exchanger. The secondary heater is sized to evaporate all of the refrigerant passing through the refrigerant flow path. A control system is operatively connected to the coolant-refrigerant heat exchanger, and is programmed to: operate the coolant-refrigerant heat exchanger in a secondary-heat-only mode in which the secondary heater evaporates the refrigerant in the refrigerant flow path without any heat input from the coolant in the coolant flow path, and to operate the coolant-refrigerant heat exchanger in a heat-scavenging mode in which at least some heat from the coolant in the coolant flow path evaporates the refrigerant in the refrigerant flow path.

### CROSS-REFERENCES TO RELATED APPLICATIONS

This application claims the benefit of U.S. Provisional Application 63/262,482, filed Oct. 13, 2021, and 63/366,861, filed Jun. 23, 2022, the contents of both of which are incorporated herein by reference in their entirety.

### FIELD OF THE DISCLOSURE

This disclosure relates generally to the field of heat exchangers and more particularly to a coolant-refrigerant heat exchanger and associated thermal management system for use in an electric vehicle.

### BACKGROUND

Thermal management systems in electric vehicles (EVs) are known to employ coolant heaters for the purpose of heating coolant that is ultimately circulated through components of the EV that require heating for performance reasons, such as the vehicle's battery. Additionally, refrigerant heaters are known in EV's for serving certain specific purposes. However, each of the existing thermal management systems suffers from certain deficiencies. It is of continued interest to improve the performance and efficiency of EV thermal management systems.

### SUMMARY

In an aspect, the disclosure relates to a thermal management system for an electric vehicle. The thermal management system includes a refrigerant system including a compressor, an interior condenser, an outside heat exchanger, and an expansion valve. The thermal management system further includes a coolant system including a pump, and a radiator. The thermal management system further includes plurality of thermal loads including a traction motor, and an energy source. The thermal management system further includes a coolant-refrigerant heat exchanger. The coolant-refrigerant heat exchanger includes a coolant flow path for transporting coolant therethrough. The coolant-refrigerant heat exchanger further includes a refrigerant flow path for transporting refrigerant therethrough, wherein the coolant flow path and the refrigerant flow path are positioned in order to transfer heat from one of the coolant and the refrigerant to the other of the coolant and the refrigerant. The coolant-refrigerant heat exchanger further includes a secondary heater that is positioned to heat both the refrigerant and the coolant in the coolant-refrigerant heat exchanger. The expansion valve is upstream from the coolant-refrigerant heat exchanger, and wherein the secondary heater is sized to evaporate all of the refrigerant passing through the refrigerant flow path. The thermal management system further includes a control system that is operatively connected to the coolant-refrigerant heat exchanger, and is programmed to:
operate the coolant-refrigerant heat exchanger in a secondary-heat-only mode in which the secondary heater evaporates the refrigerant in the refrigerant flow path without any heat input from the coolant in the coolant flow path, and
to operate the coolant-refrigerant heat exchanger in a heat-scavenging mode in which at least some heat from the coolant in the coolant flow path evaporates the refrigerant in the refrigerant flow path.

In another aspect the disclosure relates to a thermal management system for an electric vehicle. The thermal management system includes a refrigerant system including a compressor, an interior condenser, an outside heat exchanger, and an expansion valve. The thermal management system further includes a coolant system including a pump, and a radiator. The thermal management system further includes plurality of thermal loads including a traction motor, and an energy source. The thermal management system further includes a coolant-refrigerant heat exchanger. The coolant-refrigerant heat exchanger includes a coolant flow path for transporting coolant therethrough. The coolant-refrigerant heat exchanger further includes a refrigerant flow path for transporting refrigerant therethrough, wherein the coolant flow path and the refrigerant flow path are positioned in order to transfer heat from one of the coolant and the refrigerant to the other of the coolant and the refrigerant. The coolant-refrigerant heat exchanger further includes a secondary heater that is positioned to heat both the refrigerant and the coolant in the coolant-refrigerant heat exchanger. The expansion valve is upstream from the coolant-refrigerant heat exchanger, and wherein the secondary heater is sized to evaporate all of the refrigerant passing through the refrigerant flow path. The coolant-refrigerant heat exchanger is operable in a secondary-heat-only mode in which the secondary heater evaporates the refrigerant in the refrigerant flow path without any heat input from the coolant in the coolant flow path. The coolant-refrigerant heat exchanger is operable in a heat-scavenging mode in which at least some heat from the coolant in the coolant flow path evaporates the refrigerant in the refrigerant flow path.

In another aspect, the disclosure relates to a thermal management system for an electric vehicle. The thermal management system includes a refrigerant system including a compressor, an interior condenser, an outside heat exchanger, and an expansion valve. The thermal management system further includes a coolant system including a pump, and a radiator. The thermal management system further includes a plurality of thermal loads including a traction motor, and an energy source. The thermal management system further includes a coolant-refrigerant heat exchanger. The coolant-refrigerant heat exchanger includes a coolant flow path for transporting coolant therethrough. The coolant-refrigerant heat exchanger further includes a refrigerant flow path for transporting refrigerant therethrough. The coolant flow path and the refrigerant flow path are positioned in order to transfer heat from one of the coolant and the refrigerant to the other of the coolant and the refrigerant. The coolant-refrigerant heat exchanger further includes a secondary heater that is positioned to heat both the refrigerant and the coolant in the coolant-refrigerant heat exchanger. The expansion valve is upstream from the coolant-refrigerant heat exchanger. The coolant-refrigerant heat exchanger includes a plurality of flow plates each having a plurality of faces and a peripheral edge. The plurality of flow plates are sealingly joined together such that the coolant flow path and the refrigerant flow path are positioned between mutually facing ones of the faces of adjacent ones of the plurality of flow plates, and the secondary heater extends along the peripheral edge of each of the plurality of flow plates.

In yet another aspect, the disclosure relates to a coolant-refrigerant heat exchanger for a thermal management system for an electric vehicle. The coolant-refrigerant heat exchanger includes a coolant flow path for transporting coolant therethrough. The coolant-refrigerant heat exchanger further includes a refrigerant flow path for transporting refrigerant therethrough, wherein the coolant flow path and the refrigerant flow path are positioned in order to transfer heat from one of the coolant and the refrigerant to the other of the coolant and the refrigerant. The coolant-refrigerant heat exchanger further includes a secondary heater that is positioned to heat both the refrigerant and the coolant in the coolant-refrigerant heat exchanger. The expansion valve is upstream from the coolant-refrigerant heat exchanger. The coolant-refrigerant heat exchanger includes a plurality of flow plates each having a plurality of faces and a peripheral edge, wherein the plurality of flow plates are sealingly joined together such that the coolant flow path and the refrigerant flow path are positioned between mutually facing ones of the faces of adjacent ones of the plurality of flow plates, and the secondary heater extends along the peripheral edge of each of the plurality of flow plates.

In yet another aspect, the disclosure relates to a method of operating a refrigerant system in an electric vehicle, comprising:
a) compressing a refrigerant in the refrigerant system, thereby bringing the refrigerant from a first temperature and a first pressure to a second temperature and a second pressure, wherein the first temperature is sufficiently low that the first pressure is less than 1 atmosphere;
b) condensing the refrigerant after step a), thereby bringing the refrigerant from the second temperature and the second pressure to a third temperature and a third pressure;
c) passing the refrigerant through an expansion valve after step b), thereby bringing the refrigerant from the third temperature and the third pressure to a fourth temperature and a fourth pressure;
d) evaporating the refrigerant after step c), in an evaporator that is a coolant-refrigerant heat exchanger, and having a secondary heater, wherein the coolant-refrigerant heat exchanger is positioned to transfer heat between a coolant in a coolant system of the electric vehicle and the refrigerant, wherein the evaporating is carried out by heating the refrigerant using the secondary heater and without heating the refrigerant using the coolant-refrigerant heat exchanger, to bring the refrigerant from the fourth temperature and the fourth pressure to a fifth temperature and a fifth pressure, wherein the fifth temperature is sufficiently high that the fifth pressure is greater than 1 atmosphere; and
e) compressing the refrigerant after step d), thereby bringing the refrigerant from the fifth temperature and the fifth pressure to beyond the fifth temperature and beyond the fifth pressure.

In yet another aspect, the disclosure relates to a method of operating a thermal management system of an electric vehicle, the thermal management system including a refrigerant system and a coolant system, wherein the refrigerant system includes a compressor, an interior condenser, an outside heat exchanger, and an expansion valve, wherein the coolant system includes a pump, and a radiator, wherein the thermal management system includes a plurality of thermal loads including a traction motor, and an energy source, wherein the thermal management system includes a coolant-refrigerant heat exchanger that includes a coolant flow path for transporting coolant therethrough, a refrigerant flow path for transporting refrigerant therethrough, wherein the coolant flow path and the refrigerant flow path are positioned in order to transfer heat from one of the coolant and the refrigerant to the other of the coolant and the refrigerant, and a secondary heater that is positioned to heat both the refrigerant and the coolant in the coolant-refrigerant heat exchanger, wherein the expansion valve is upstream from the coolant-refrigerant heat exchanger, and wherein the secondary heater is sized to evaporate all of the refrigerant passing through the refrigerant flow path, the method comprising:
a) operating the coolant-refrigerant heat exchanger in a secondary-heat-only mode in which the secondary heater evaporates the refrigerant in the refrigerant flow path without any heat input from the coolant in the coolant flow path; and
b) operating the coolant-refrigerant heat exchanger in a heat-scavenging-only mode in which the coolant in the coolant flow path evaporates the refrigerant in the refrigerant flow path without any heat input from the secondary heater.

In another aspect the disclosure relates to a thermal management system for an electric vehicle. The thermal management system includes a refrigerant system including a compressor, an interior condenser, an outside heat exchanger, and an expansion valve. The thermal management system further includes a coolant system including a pump, and a radiator. The thermal management system further includes a plurality of thermal loads including a traction motor, and an energy source. The thermal management system further includes a coolant-refrigerant heat exchanger. The coolant-refrigerant heat exchanger includes a coolant flow path for transporting coolant therethrough. The coolant-refrigerant heat exchanger further includes a refrigerant flow path for transporting refrigerant therethrough. The coolant flow path and the refrigerant flow path are positioned in order to transfer heat from one of the coolant and the refrigerant to the other of the coolant and the refrigerant. The coolant-refrigerant heat exchanger further includes a secondary heater that is positioned to heat both the refrigerant and the coolant in the coolant-refrigerant heat exchanger. The expansion valve is upstream from the coolant-refrigerant heat exchanger, and wherein the secondary heater is sized to evaporate all of the refrigerant passing through the refrigerant flow path. The thermal management system further includes a control system that is operatively connected to the coolant-refrigerant heat exchanger, and is programmed to:
operate the outside heat exchanger as an evaporator to evaporate the refrigerant without operating the coolant-refrigerant heat exchanger, and
operate the coolant-refrigerant heat exchanger in a secondary-heat-only mode in which the secondary heater evaporates the refrigerant in the refrigerant flow path without using the outside heat exchanger.

In yet another aspect, the disclosure relates to a method of controlling a coolant-refrigerant heat exchanger in a thermal management system of a vehicle, the thermal management system including a refrigerant system and a coolant system, wherein the refrigerant system includes a compressor, an interior condenser, an outside heat exchanger, and an expansion valve, wherein the coolant system includes a pump, and a radiator, wherein the thermal management system includes a plurality of thermal loads including a traction motor, and an energy source, wherein the thermal management system includes a coolant-refrigerant heat exchanger that includes a coolant flow path for transporting coolant therethrough, a refrigerant flow path for transporting refrigerant therethrough, wherein the coolant flow path and the refrigerant flow path are positioned in order to transfer heat from one of the coolant and the refrigerant to the other of the coolant and the refrigerant, and a secondary heater that is positioned to heat both the refrigerant and the coolant in the coolant-refrigerant heat exchanger, wherein the expansion valve is upstream from the coolant-refrigerant heat exchanger, and wherein the secondary heater is sized to evaporate all of the refrigerant passing through the refrigerant flow path, the method comprising:
a) checking if a passenger cabin of the vehicle is at or is greater than a target cabin temperature;
b) based on step a), checking if a temperature of the refrigerant at an inlet to the coolant-refrigerant heat exchanger is less than an ambient temperature minus a selected minimum temperature differential; and
c) based on step b), reducing power to the secondary heater.

### BRIEF DESCRIPTION OF THE DRAWINGS

The foregoing and other aspects of the invention will be better appreciated with reference to the attached drawings, as follows:

FIG. 1 is a schematic view of a basic vehicular air conditioning system using refrigerant, in accordance with the prior art.

FIG. 2 is a pressure-enthalpy chart for the refrigerant in the air conditioning system shown in FIG. 1.

FIG. 3A is a schematic view of a basic vehicular heat pump system, in accordance with the prior art, in a cooling mode.

FIG. 3B is a schematic view of the heat pump system shown in FIG. 3A, in a heating mode.

FIG. 4 is a pressure-enthalpy chart for the refrigerant in the air conditioning system shown in FIG. 1.

FIG. 5 is a schematic view of a vehicular thermal management system that incorporates a coolant system and a refrigerant system, in accordance with an embodiment of the present disclosure.

FIG. 6 is a perspective view of a coolant-refrigerant heat exchanger, in accordance with an embodiment of the present disclosure, which includes a secondary heater.

FIGS. 7a and 7b together are a perspective exploded view of the coolant-refrigerant heat exchanger shown in FIG. 6.

FIG. 8 is a magnified perspective view of a portion of the coolant-refrigerant heat exchanger shown in FIG. 6.

FIG. 9 is a perspective sectional view of the coolant-refrigerant heat exchanger shown in FIG. 6.

FIG. 10 is a perspective, partially-exploded view of a portion of the coolant-refrigerant heat exchanger shown in FIG. 10, illustrating the flow of coolant and refrigerant therethrough.

FIG. 11 is a schematic illustration showing the flow of coolant and refrigerant through the coolant-refrigerant heat exchanger shown in FIG. 6.

FIG. 12 is a schematic illustration showing an alternative flow path for coolant and refrigerant through an alternative embodiment of the coolant-refrigerant heat exchanger shown in FIG. 6.

FIG. 13 is a schematic illustration of a thermal management system in accordance with an embodiment of the present disclosure, incorporating the coolant-refrigerant heat exchanger shown in FIG. 6, in a cabin heating mode using the secondary heater.

FIG. 14 is a schematic illustration of the thermal management system shown in FIG. 13, in a cabin heating mode using the secondary heater and an outside heat exchanger.

FIG. 15 is a schematic illustration of the thermal management system shown in FIG. 13, in a cabin heating mode using the secondary heater and scavenging heat from coolant.

FIG. 16 is a schematic illustration of the thermal management system shown in FIG. 13, in a battery preheating mode using the secondary heater.

FIG. 17 is a schematic illustration of the thermal management system shown in FIG. 13, in a cabin heating and battery heating mode using the secondary heater.

FIG. 18 is a schematic illustration of the thermal management system shown in FIG. 13, in a cabin heating mode using the outside heat exchanger.

FIG. 19 is a schematic illustration of the thermal management system shown in FIG. 13, in a cabin heating and defogging mode using the outside heat exchanger.

FIG. 20 is a schematic illustration of the thermal management system shown in FIG. 13, in a cabin cooling mode.

FIG. 21 is a schematic illustration of the thermal management system shown in FIG. 13, in a cabin cooling and battery cooling mode.

FIG. 22 is a schematic illustration of the thermal management system shown in FIG. 13, in a battery cooling mode.

FIG. 23 is a side elevation view of an electric vehicle incorporating the thermal management system shown in FIG. 13.

FIG. 24 is a pressure-enthalpy chart for the refrigerant in the thermal management system shown in FIG. 13.

FIG. 25 is a flow diagram of a method of controlling the secondary heater shown in FIG. 7b, when the thermal management system is operated in the mode shown in FIG. 13.

FIG. 26 is a flow diagram of a method of controlling the secondary heater shown in FIG. 7b, when the thermal management system is operated in the mode shown in FIG. 14.

FIG. 27 is a sectional side view of a portion of a plurality of flow plates that are part of the coolant-refrigerant heat exchanger shown in FIGS. 6-10, in an intermediate stage of manufacture of the coolant-refrigerant heat exchanger.

FIG. 28 is a sectional side view of the portion of the plurality of flow plates shown in FIG. 27, in a subsequent intermediate stage of manufacture of the coolant-refrigerant heat exchanger showing a heat exchange surface.

### DETAILED DESCRIPTION OF EXAMPLE EMBODIMENTS

For simplicity and clarity of illustration, where considered appropriate, reference numerals may be repeated among the Figures to indicate corresponding or analogous elements. In addition, numerous specific details are set forth in order to provide a thorough understanding of the embodiment or embodiments described herein. However, it will be understood by those of ordinary skill in the art that the embodiments described herein may be practiced without these specific details. In other instances, well-known methods, procedures and components have not been described in detail so as not to obscure the embodiments described herein. It should be understood at the outset that, although exemplary embodiments are illustrated in the figures and described below, the principles of the present disclosure may be implemented using any number of techniques, whether currently known or not. The present disclosure should in no way be limited to the exemplary implementations and techniques illustrated in the drawings and described below.

Various terms used throughout the present description may be read and understood as follows, unless the context indicates otherwise: “or” as used throughout is inclusive, as though written “and/or”; singular articles and pronouns as used throughout include their plural forms, and vice versa; similarly, gendered pronouns include their counterpart pronouns so that pronouns should not be understood as limiting anything described herein to use, implementation, performance, etc. by a single gender; “exemplary” should be understood as “illustrative” or “exemplifying” and not necessarily as “preferred” over other embodiments. Further definitions for terms may be set out herein; these may apply to prior and subsequent instances of those terms, as will be understood from a reading of the present description.

Modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set.

The indefinite article “a” is not intended to be limited to mean “one” of an element. It is intended to mean “one or more” of an element, where applicable, (i.e. unless in the context it would be obvious that only one of the element would be suitable).

Any reference to upper, lower, top, bottom or the like are intended to refer to an orientation of a particular element during use of the claimed subject matter and not necessarily to its orientation during shipping or manufacture. The upper surface of an element, for example, can still be considered its upper surface even when the element is lying on its side.

### Description of Basic Air Conditioning System

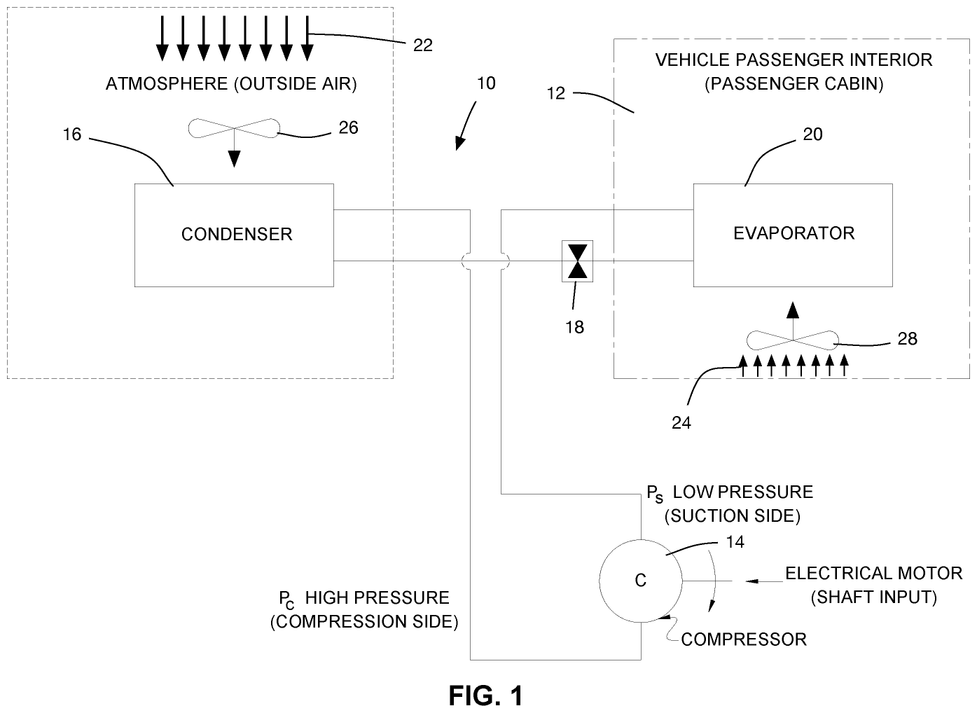

Reference is made to FIG. 1, which shows schematic diagram of a typical vehicular air conditioning system 10, in accordance with the prior art. It will be noted that the air conditioning system 10 shown in FIG. 1 has been simplified in the sense that several components that are typically present, have been omitted here for simplicity.

The air conditioning system 10 shown in FIG. 1 circulates a refrigerant through various components in order to cool a vehicle's passenger cabin (shown schematically at 12). The air conditioning system 10 employs a compressor 14, a condenser 16, an expansion valve 18, and an evaporator 20.

The refrigerant enters the compressor 14 at a relatively low pressure, such as, for example, about 140 kPa, and a relatively low temperature such as, for example, −25 degrees Celsius. The compressor 14 compresses the refrigerant, to bring the refrigerant to a high pressure, such as, for example, about 1200 kPa. The compression of the refrigerant raises its temperature to, for example, about 110 degrees Celsius. As a result, the refrigerant is a high pressure, high temperature gas when leaving the compressor. The refrigerant then passes to the condenser 16. The condenser 16 is used to condense the refrigerant, by carrying out heat transfer from the refrigerant flowing therethrough to the air that surrounds the condenser 16. The condenser 16 is positioned outside the passenger cabin 12, such as in the engine compartment, shown at 21, in embodiments in which the vehicle includes an engine. As a result of its placement, the condenser 16 is exposed to outside air, shown at 22, (which is air from outside the passenger cabin 12), as distinguished from interior air, shown at 24, (which is air from inside the passenger cabin 12). An outside fan 26 is provided to enhance the flow of the outside air 22 over the condenser 16. The temperature of the outside air 22 is lower than that of the refrigerant, and so the refrigerant condenses in the condenser 16, and leaves the condenser 16 as a liquid.

The refrigerant then passes through the expansion valve 18, so as to reduce the pressure of the refrigerant. Some of the refrigerant may evaporate due to the reduction in pressure, however, a significant portion of the refrigerant remains liquid. The reduction in pressure of the refrigerant cools the refrigerant. Thus, the refrigerant leaves the expansion valve 18 as a low pressure, low temperature liquid or liquid/gas mix. The refrigerant then passes through the evaporator 20, which transfers heat from the interior air 24 to the refrigerant, in order to raise the temperature of the refrigerant so as to drive the evaporation of the refrigerant. An interior fan 28 may be provided to encourage the flow of interior air 24 over the evaporator 20. The evaporator 20 is positioned inside the passenger cabin 12 in the sense that the evaporator 20 may be positioned aft of the firewall in the vehicle, which separates the engine compartment 21 from the passenger cabin 12, and, more importantly, is exposed to a flow of the interior air 24. For greater clarity, the interior air 24 is air that is directed into the passenger cabin 12. Raising the temperature of the refrigerant in the evaporator 20 correspondingly cools the interior air 24, thereby cooling the interior air 24.

The refrigerant then leaves the evaporator 20 and returns to the inlet of the compressor 14, where it is compressed again and sent again to the condenser 16 in a continuous cycle.

### Description of Basic Pressure-Enthalpy Chart

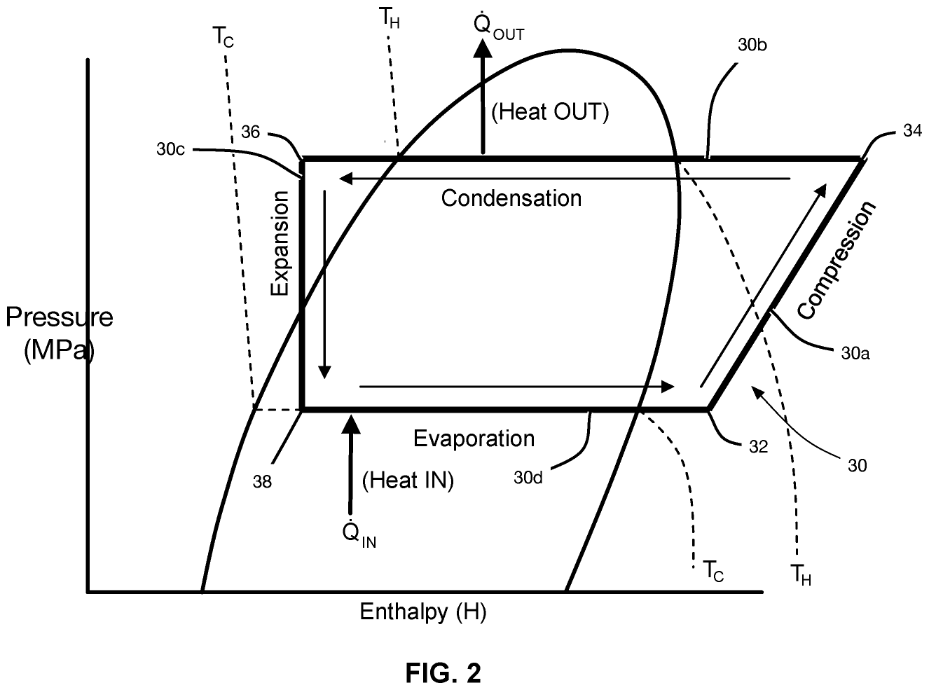

FIG. 2 is a pressure-enthalpy chart that shows the refrigeration cycle that the refrigerant undergoes, in a graphical format. As will be understood by one skilled in the art, the inverted U-shaped line represents the gas/liquid transition properties for the refrigerant. The dot-dash curve shown at 30 represents the changes in the properties of the refrigerant as it passes through the refrigeration cycle shown in FIG. 1. Point 32 represents the properties of the refrigerant immediately upstream of the compressor 14. Curve segment 30a is representative of the change in the properties of the refrigerant due to operation of the compressor 14. Point 34 is representative of the properties of the refrigerant downstream of the compressor 14 and upstream from the condenser 16. As can be seen, the pressure and the temperature of the refrigerant increase between point 32 and point 34.

Curve segment 30b is representative of the change in the properties of the refrigerant due to operation of the condenser 16. Point 36 is representative of the properties of the refrigerant immediately downstream of the condenser 16 (and therefore upstream from the expansion valve 18). As can be seen, the temperature of the refrigerant decreases and then remains constant during the phase change that occurs in the condenser 16.

Curve segment 30c is representative of the change in the properties of the refrigerant due to the expansion valve 18. Point 38 is representative of the properties of the refrigerant immediately downstream of the expansion valve 18 and therefore upstream from the evaporator 20). As can be seen, the pressure and temperature of the refrigerant decrease as a result of passing through the expansion valve.

Curve segment 30d is representative of the change in the properties of the refrigerant due to passage through the evaporator 20. After passing through the evaporator 20, the refrigerant returns to point 32, which is representative of the properties of the refrigerant immediately downstream of the evaporator 20 (and therefore of the properties of the refrigerant immediately upstream of the compressor 14). As can be seen, the pressure and the temperature remain substantially constant in the evaporator 20. This is because the heat being transferred to the refrigerant is being used to drive the phase change (i.e. the evaporation) of the refrigerant, which occurs at a constant temperature, as will be understood by one skilled in the art. Optionally, the evaporator 20 may be sized to transfer to the refrigerant a bit more than the minimum amount of heat that is needed to evaporate all of the refrigerant, so as to drive an increase in temperature of the refrigerant once all of it has evaporated. This ensures that all of the refrigerant leaves the evaporator as a gas, with no fraction thereof remaining as a liquid. It is advantageous for all of the refrigerant to be in gaseous form when reaching the inlet of the compressor 14 so as to avoid damaging the compressor 14.

### Description of Basic Heat Pump System

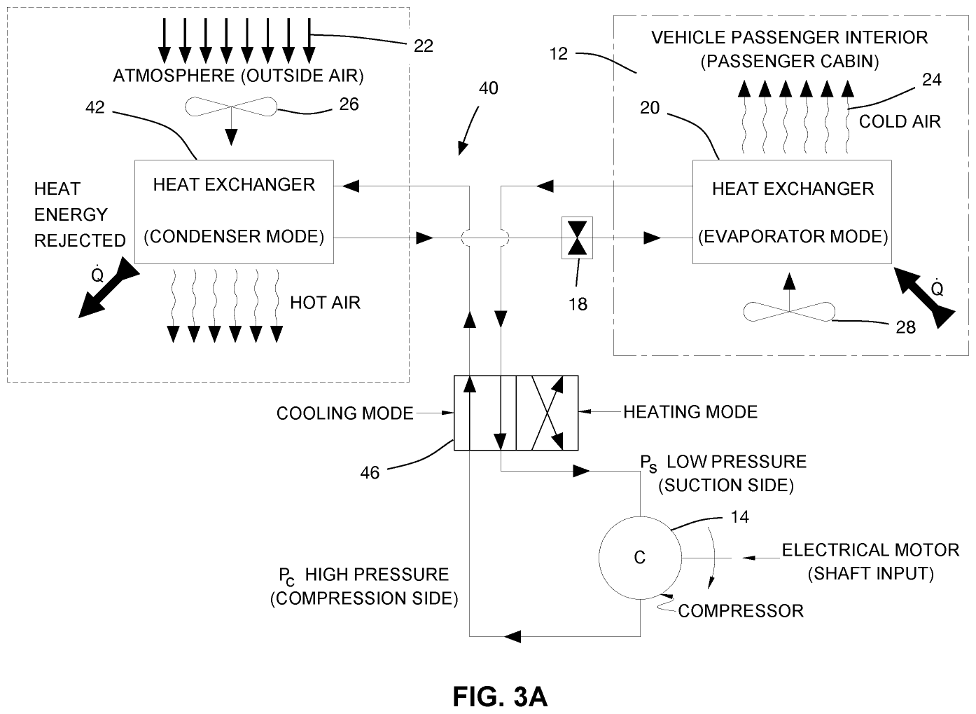

FIGS. 3A and 3B show a thermal management system that is more sophisticated than the air conditioning system shown in FIG. 1. The thermal management system may be referred to as a heat pump system and is shown at 40. The heat pump system 40 is similar to the air conditioning system 10 and includes the compressor 14 and the expansion valve 18, but also includes some different components. For example, the heat pump system 40 includes an outside heat exchanger 42 and an interior heat exchanger 44 instead of the condenser 16 and evaporator 20 shown in FIG. 1, respectively. The heat pump system 40 further includes a reversing valve 46, which is explained further below. The heat pump system 40 is capable of cooling the passenger cabin 12 in similar manner to the air conditioning system 10, but is also capable of heating the passenger cabin 12, using little extra equipment.

The outside heat exchanger 42 may be similar to the condenser 16 in the sense that the outside heat exchanger 42 is usable to carry out heat transfer from the refrigerant flowing therethrough to the air that surrounds the outside heat exchanger 42, in order to condense the refrigerant, but is also capable of receiving a flow of refrigerant liquid in the opposite direction therethrough in order to carry out heat transfer thereto from the air that surrounds the outside heat exchanger 42, in order to evaporate the refrigerant.

The interior heat exchanger 44 may be similar to the evaporator 20 in the sense that the interior heat exchanger 44 is inside the passenger cabin 12 and is usable to carry out heat transfer to the refrigerant flowing therethrough from the air that surrounds the interior heat exchanger 44, in order to evaporate the refrigerant, but is also capable of receiving a flow of refrigerant gas in the opposite direction therethrough in order to carry out heat transfer from the refrigerant to the air that surrounds the interior heat exchanger 44, in order to condense the refrigerant.

The reversing valve 46 is positionable in a plurality of positions, including a first position (FIG. 3A) in which the reversing valve 46 transfers refrigerant flow from the compressor 14 to the outside heat exchanger 42 and from the interior heat exchanger 44 to the compressor 14, and a second position in which the reversing valve 46 transfers refrigerant flow to the interior heat exchanger 44 from the compressor 14 and to the compressor 14 from the outside heat exchanger 42.

The heat pump system 40 is operable in a first mode (FIG. 3A), in which the reversing valve 46 is in the first position, used for cooling the passenger cabin 12, and a second mode (FIG. 3B), in which the reversing valve 46 is in the second position, used for heating the passenger cabin 12.

The first mode (FIG. 3A) is described as follows: The refrigerant enters the compressor 12 at a relatively low pressure, and a relatively low temperature. The compressor 12 compresses the refrigerant, to bring the refrigerant to a high pressure, which raises its temperature. As a result, the refrigerant is a high pressure, high temperature gas when leaving the compressor. The refrigerant then passes to the outside heat exchanger 42. The outside heat exchanger 42 acts as a condenser and is used to condense the refrigerant, by carrying out heat transfer from the refrigerant flowing therethrough to the outside air 22 that surrounds the outside heat exchanger 42. Optionally the outside fan 26 is provided to enhance air flow across the outside heat exchanger 42, and therefore enhances heat transfer from the outside heat exchanger 42. The refrigerant then passes through the expansion valve 18, so as to reduce the pressure of the refrigerant. Some of the refrigerant may evaporate due to the reduction in pressure, however, a significant portion of the refrigerant remains liquid. The reduction in pressure of the refrigerant cools the refrigerant. Thus, the refrigerant leaves the expansion valve 18 as a low pressure, low temperature liquid or liquid/gas mix. The refrigerant then passes through the interior heat exchanger 44, which acts as an evaporator and which transfers heat from the interior air 24 to the refrigerant (thereby cooling the interior air 24), in order to raise the temperature of the refrigerant so as to drive the evaporation of the refrigerant. Optionally the interior fan 28 is provided and is used to enhance air flow across the interior heat exchanger 44, and therefore enhances heat transfer from the interior air 24 to the refrigerant. The cooled interior air 24 cools the passenger cabin 12. The refrigerant then passes to the inlet of the compressor 14, where it is compressed again and sent again to the reversing valve 46 in a continuous cycle.

The second mode (FIG. 3B) is described as follows: The refrigerant enters the compressor 12 at a relatively low pressure, and a relatively low temperature. The compressor 12 compresses the refrigerant, to bring the refrigerant to a high pressure, which raises its temperature. As a result, the refrigerant is a high pressure, high temperature gas when leaving the compressor 14. The refrigerant then passes to the interior heat exchanger 44, which acts as a condenser and is used to condense the refrigerant, by carrying out heat transfer from the refrigerant flowing therethrough to the interior air 24 that surrounds the interior heat exchanger 44 (thereby heating the interior air 24). Optionally the interior fan 28 is provided to enhance air flow across the interior heat exchanger 44, and therefore enhances heat transfer from the refrigerant to the interior air 24. The heated interior air 24 heats the passenger cabin 12. The refrigerant then passes through the expansion valve 18, so as to reduce the pressure of the refrigerant. Some of the refrigerant may evaporate due to the reduction in pressure, however, a significant portion of the refrigerant remains liquid. The reduction in pressure of the refrigerant cools the refrigerant. Thus, the refrigerant leaves the expansion valve 18 as a low pressure, low temperature liquid or liquid/gas mix. The refrigerant then passes through the outside heat exchanger 42, which acts as an evaporator and which transfers heat from the outside air 22 to the refrigerant, in order to raise the temperature of the refrigerant so as to drive the evaporation of the refrigerant. Optionally the outside fan 28 is provided and is used to enhance air flow across the outside heat exchanger 42, and therefore enhances heat transfer from the outside air 22. The refrigerant then passes to the inlet of the compressor 14, where it is compressed again and sent again to the reversing valve 46 in a continuous cycle.

Thus, by moving the reversing valve 46 between the first and second positions, the heat pump system 40 can be used to either heat or cool the passenger cabin, as desired.

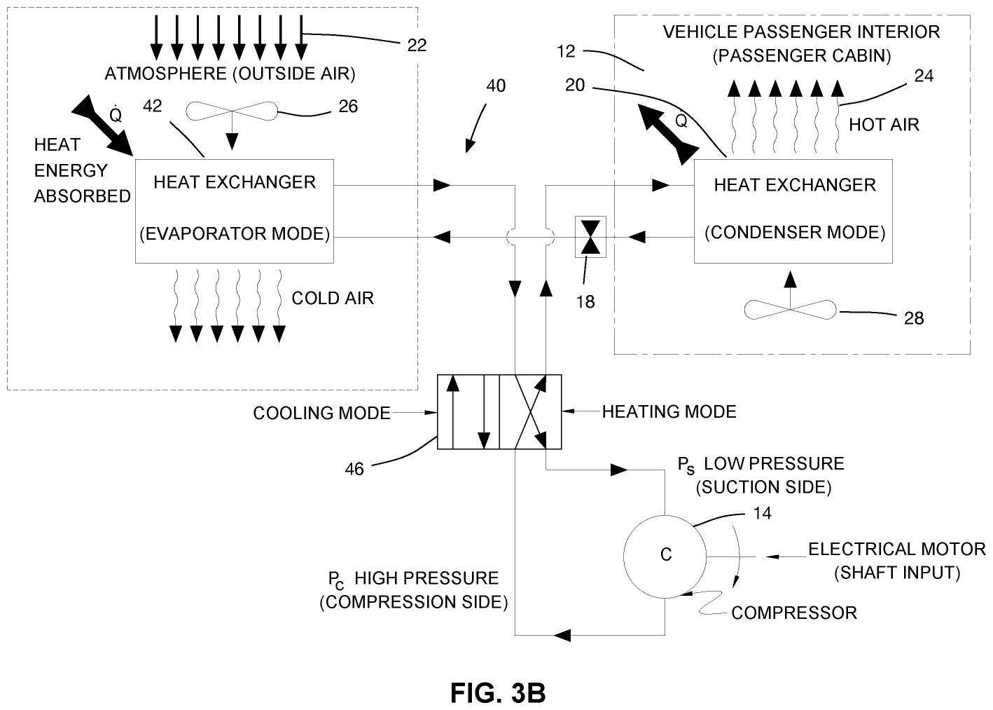

FIG. 4 is a pressure-enthalpy diagram illustrating the property changes that the refrigerant undergoes during operation of the heat pump system 40 shown in FIGS. 3A and 3B. As can be seen the general shape of the curve 30 in FIG. 4 is similar to the shape of the curve 30 in FIG. 2.

It will be noted that in a heat pump system such as the heat pump system 40, the refrigerant properties undergo the same cycle of compression, condensation, reduction in pressure, and evaporation, regardless of whether the heat pump system 40 is operating in the first mode or the second mode. Referring to FIG. 4, point 32 corresponds to the properties of the refrigerant immediately upstream of the compressor, as before. Point 34 corresponds to the properties of the refrigerant downstream from the compressor 14 and upstream from the outside heat exchanger 42 when operating in the first mode, and downstream from the compressor and upstream from the interior heat exchanger 44 when operating in the second mode. Point 36 corresponds to the properties of the refrigerant downstream from the outside heat exchanger 42 and upstream from the expansion valve 18 when operating in the first mode, and downstream from the interior heat exchanger 44 and upstream from the expansion valve 18 when operating in the second mode. Point 38 corresponds to the properties of the refrigerant downstream from the expansion valve 18 and upstream from the interior heat exchanger 44 when operating in the first mode, and downstream from the expansion valve 18 and upstream from the outside heat exchanger 42 when operating in the second mode.

Description of Thermal Management System with Coolant-Refrigerant Heat Exchanger

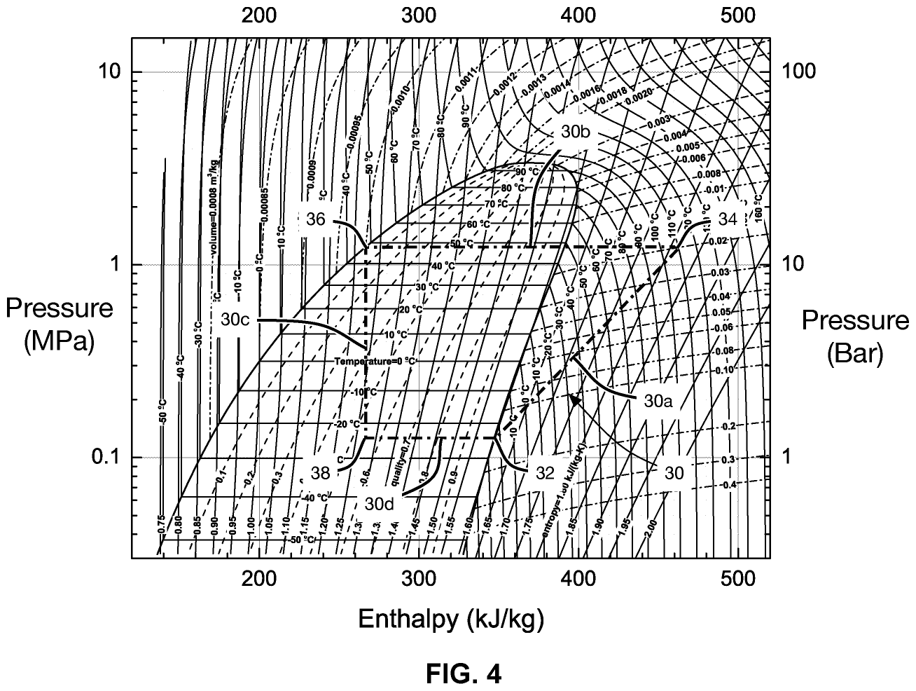

FIG. 5 shows a thermal management system 50 that is more sophisticated than the heat pump system 40 shown in FIGS. 3A and 3B. The thermal management system 50 shown in FIG. 5 includes a refrigerant system 52 and a coolant system 54. In FIG. 5, a solid line represents a coolant conduit, and a dashed line represents a refrigerant conduit. The refrigerant system 52 includes a compressor 56, a plurality of control valves shown at V1, V2, V3, and V4, a plurality of refrigerant check valves shown at CV1, CV2, CV3 and CV4, a plurality of expansion valves shown at EXV1, EXV2, and EXV3, an outside heat exchanger 58, an interior evaporator 60, and an interior condenser 62. The control valves V1, V2, V3 and V4 may be simple on-off valves (e.g. solenoid valves). The outside heat exchanger 58 may be similar to the outside heat exchanger 16 shown in FIGS. 3A and 3B. The evaporator 60 and the interior condenser 62 may be provided instead of the interior heat exchanger 20 of FIGS. 3A and 3B, in order to enable enhanced functionality (e.g. both heating and defogging simultaneously), or for other reasons.

The coolant system 54 includes a first pump 64, a second pump 66, a plurality of control valves shown at 68a and 68b, a coolant check valve shown at 70, a high voltage heater 71, and a radiator 72. Thermal loads may be present. In the case where the vehicle is an EV, the thermal loads may include, for example, a traction battery 74, and a traction motor 76 (including associated power electronics). A coolant-refrigerant heat exchanger 78 is provided, for heat exchange between the coolant in the coolant system 54 and the refrigerant in the refrigerant system 52. The coolant-refrigerant heat exchanger 78 has a coolant flow path 78a therethrough, and a refrigerant flow path 78b therethrough.

The operation of the thermal management system 50 is described as follows: The refrigerant system 52 is operable in a greater number of modes than the heat pump system 40 shown in FIGS. 3A and 3B. Such modes include a first mode, to heat the passenger cabin 12 using heat from the coolant in the coolant system 54 via the coolant-refrigerant heat exchanger 78, a second mode, to heat the passenger cabin 12 using heat from the coolant in the coolant system 54, and also using the outside heat exchanger 58 as an evaporator, and a third mode, to cool the passenger cabin 12, using the outside heat exchanger 58 as a condenser.

In the first mode, the control valves V1, V2, V3 and V4 are controlled so as to direct refrigerant flow from the compressor 56, through the control valve V2, and through the interior condenser 62, where the refrigerant condenses and transfers heat to the interior air shown at 24, in order to heat the passenger cabin 12. From the interior condenser 62, the refrigerant passes through the check valve CV1. Downstream from the check valve CV1, the refrigerant flow may be directed through a first refrigerant flow path 80a through an optional refrigerant-refrigerant heat exchanger 80, through the expansion valve EXV3, through the coolant-refrigerant heat exchanger 78, back through a second refrigerant flow path 80b through the refrigerant-refrigerant heat exchanger 80, and back to the inlet of the compressor 56. In the refrigerant-refrigerant heat exchanger 80, some heat is scavenged from the refrigerant in the first refrigerant flow path 80a to add heat to the refrigerant in the second refrigerant flow path 80b so as to further superheat the refrigerant in the second refrigerant flow path 80b to reduce the chance of any liquid refrigerant being present in that flow that could damage the compressor 56 that is downstream from it.

In the coolant-refrigerant heat exchanger 78, the refrigerant receives heat from the coolant flowing therethrough, thereby driving evaporation of the refrigerant, which is at low pressure as a result of passing through the third expansion valve EXV3. The coolant may be heated by one or more of several sources. This includes the traction battery 74, and/or the traction motor 76 (and the associated power electronics), and/or the high voltage heater 71. More specifically, during discharging, and during charging, of the traction battery 74, heat is generated, which is transmitted to the coolant. Additionally the traction motor 76 and the associated power electronics generate heat during operation of the traction motor 76. In some situations however, such as upon vehicle startup when it is very cold outside, the traction battery 74 and the traction motor 76 may not be warm enough to provide sufficient heat to the coolant for heating the refrigerant in the coolant-refrigerant heat exchanger 78. In such situations, the high voltage heater 71 may be operated to heat the coolant, in order to heat the refrigerant in the coolant-refrigerant heat exchanger 78 sufficiently to evaporate the refrigerant. The refrigerant then passes from the coolant-refrigerant heat exchanger 78 to the second refrigerant flow path 80b in the refrigerant-refrigerant heat exchanger 80, and from there to the inlet of the compressor 56.

Optionally, a receiver/dryer 97 is provided to remove contaminants from the refrigerant, such as oils, water, dirt and debris as these contaminants can damage components such as the compressor 56.

In the first mode described above, all of the refrigerant flow passes through the coolant-refrigerant heat exchanger 78. In the second mode of operation, only a first portion of the refrigerant passes through the coolant-refrigerant heat exchanger 78 as described above, and a second portion of the refrigerant passes to the first expansion valve EXV1, where its pressure will be reduced. From there, the second portion of the refrigerant travels to the outside heat exchanger 58, which will act as an evaporator, in order to evaporate the second portion of the refrigerant. The evaporated refrigerant passes from the outside heat exchanger 58 through the control valve V3, through the check valve CV3, and through the second refrigerant flow path 80b in the refrigerant-refrigerant heat exchanger 80 along with the first portion of the refrigerant, and from there to the inlet of the compressor 56.

In the third mode of operation for the thermal management system 50, the control valves V1, V2, V3 and V4 are controlled so as to direct refrigerant flow from the compressor 56, through the control valve V1, through the outside heat exchanger 58, which acts as a condenser, through the check valve CV2, through the first refrigerant flow path 80a through the refrigerant-refrigerant heat exchanger 80, through the second expansion valve EXV2, where the pressure of the refrigerant is reduced, and then through the interior evaporator 60 where the refrigerant is evaporated, thereby cooling the interior air 24, so as to cool the passenger cabin 12. From the interior evaporator 60, the refrigerant passes through the second refrigerant flow path 80b of the refrigerant-refrigerant heat exchanger 80, and from there to the inlet of the compressor 56.

The thermal management system 50 is advantageous over the heat pump system 40 shown in FIGS. 3A and 3B, in that the coolant-refrigerant heat exchanger 78 permits heat from the coolant to be used to help heat the refrigerant in situations where such heat is available and/or beneficial.

### Description of Structure of Novel Coolant-Refrigerant Heat Exchanger

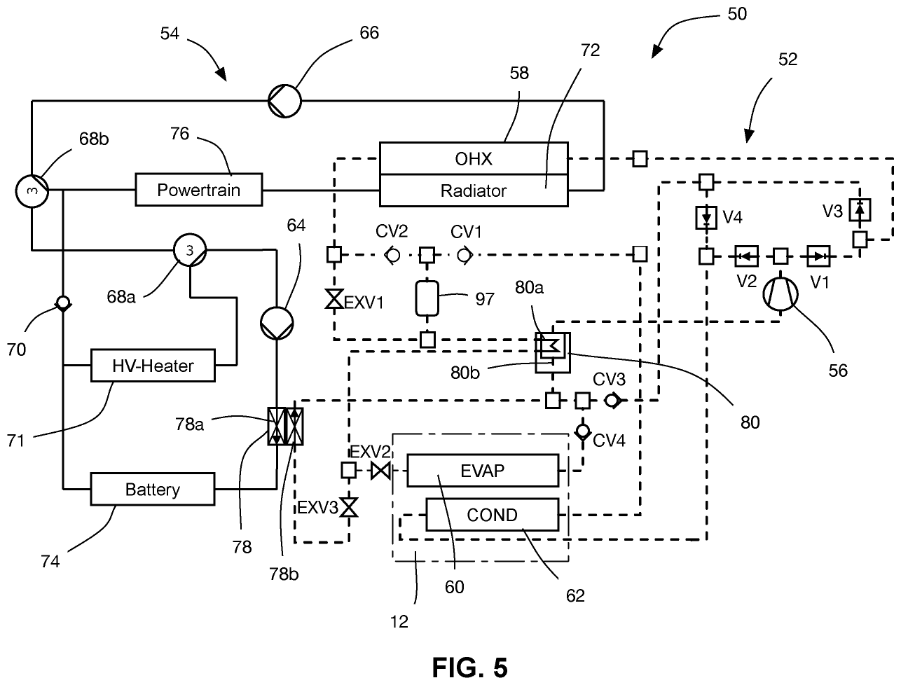

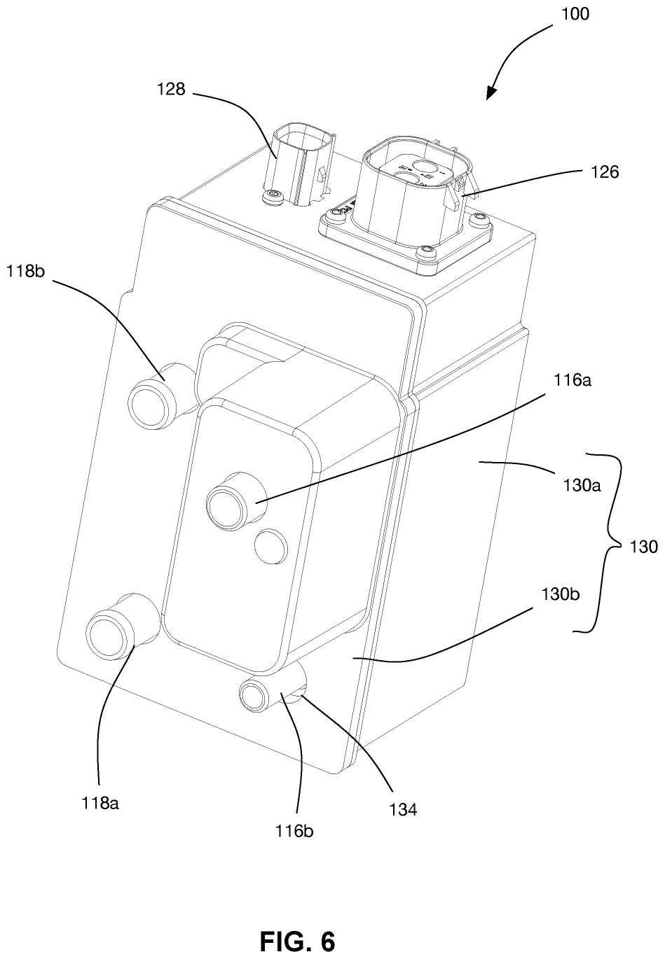

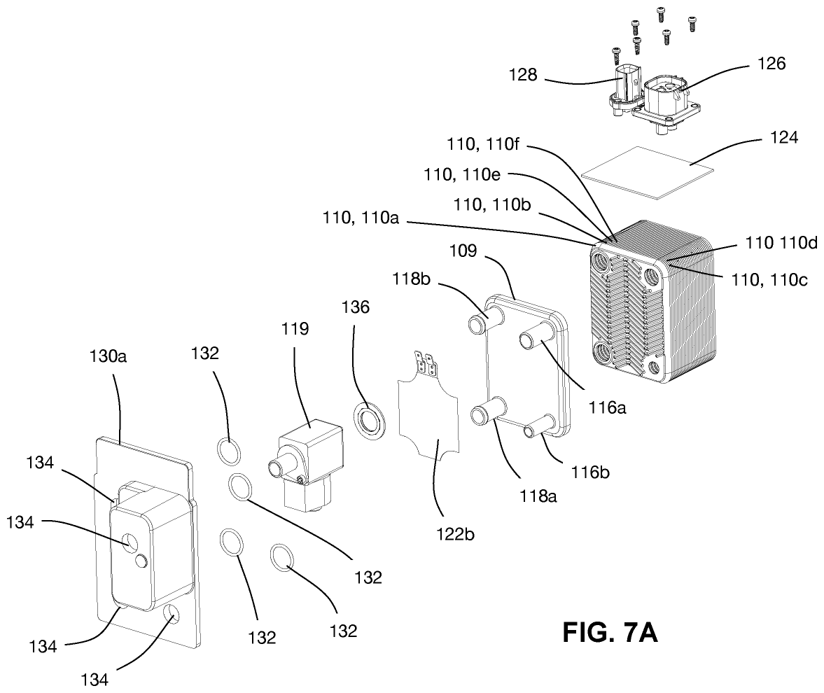

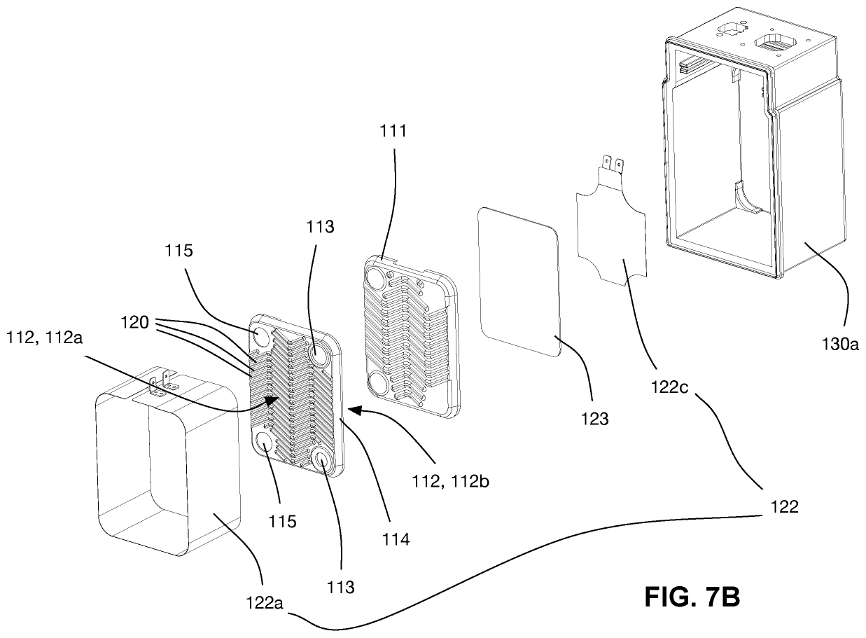

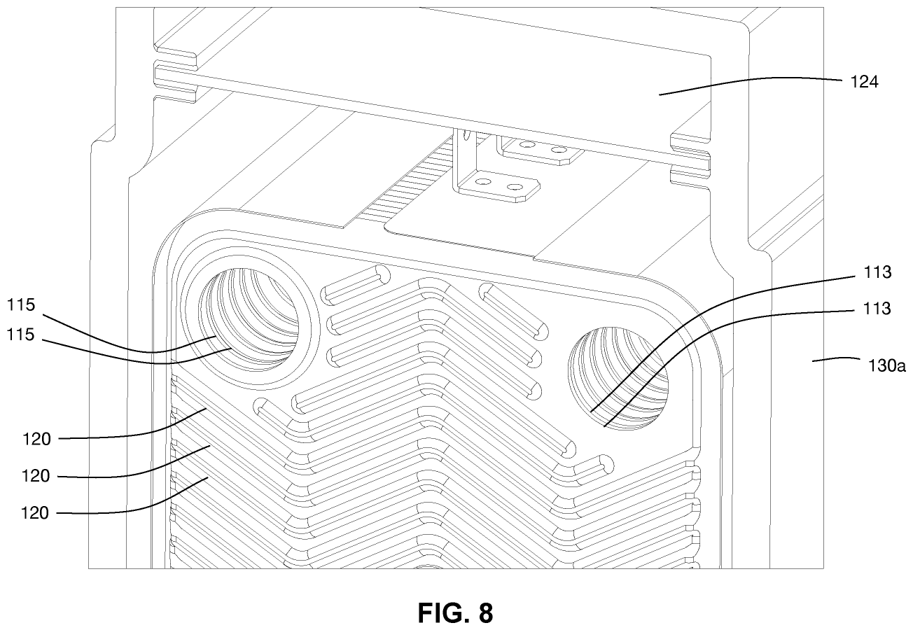

Reference is made to FIGS. 6-10, which show a coolant-refrigerant heat exchanger 100 in accordance with an embodiment of the present disclosure. FIG. 6 is a perspective view of the coolant-refrigerant heat exchanger 100. FIGS. 7a and 7b together are a perspective exploded view of the coolant-refrigerant heat exchanger 100. FIG. 8 is a magnified perspective view of a portion of the coolant-refrigerant heat exchanger 100. FIG. 9 is a sectional view of the coolant-refrigerant heat exchanger 100, and FIG. 10 is a partially exploded perspective view of a portion of the coolant-refrigerant heat exchanger 100.

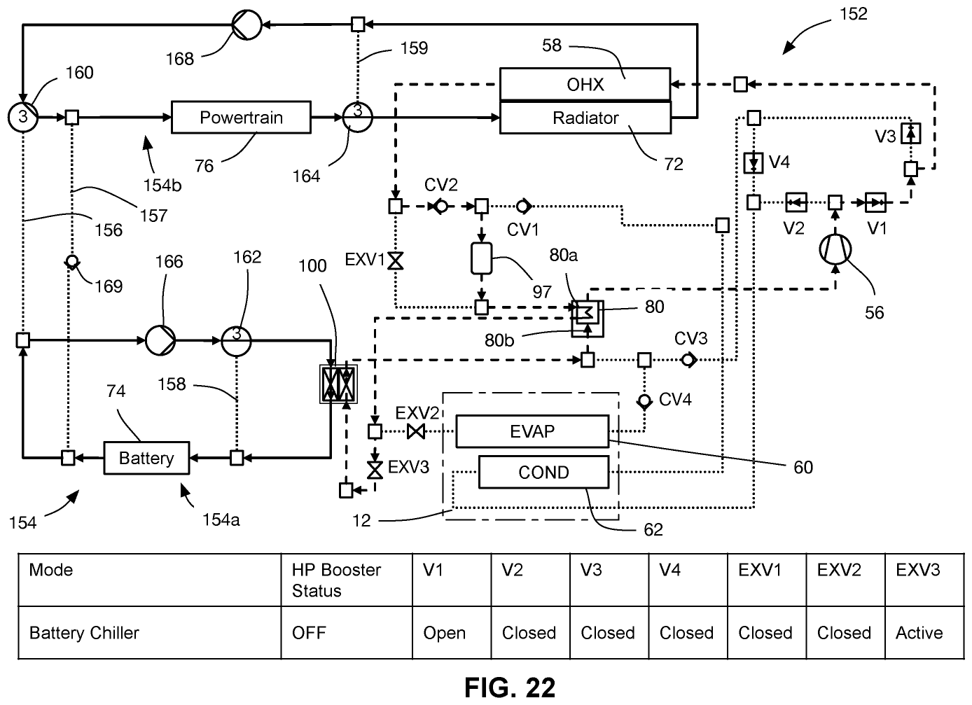

The coolant-refrigerant heat exchanger 100 may be for use in an electric vehicle 151 shown in FIG. 23. The electric vehicle 151 may include the passenger cabin 12, the traction battery 74, and the traction motor 76 (for driving one or more of the wheels shown at 99). The electric vehicle 151 may be any type of vehicle that employs a traction motor and a traction battery for supplying power to the traction motor. The electric vehicle 151 is shown as an SUV, but it could be an automotive, a light-duty truck, a heavy-duty truck, an off-road vehicle, a vehicle used in construction, an aircraft, or any other suitable type of vehicle. Furthermore, the electric vehicle 151 may contain only a traction motor (or several of them) for driving movement of the electric vehicle 151, or alternatively, it may contain an internal combustion engine, such as a range extender engine to assist in recharging the traction battery 74 when the traction battery 74 at or near depletion. In yet other embodiments, the electric vehicle 151 may be a fuel-cell vehicle, generating electric power via a fuel cell, for powering the traction motor 76.

It will be noted that the traction battery 74 shown in the figures is just one example of an energy source for the electric vehicle 151. In embodiments in which the electric vehicle 151 is a fuel-cell vehicle, the electric vehicle 151 includes a fuel-cell stack and may also include a traction battery (albeit a smaller one than in a typical battery-electric vehicle). The fuel-cell stack and the traction battery (if one is provided) would constitute an energy source for the fuel-cell vehicle. In the embodiments shown herein, the energy source is a traction battery that is connected to the traction motor to provide electrical power to the traction motor.

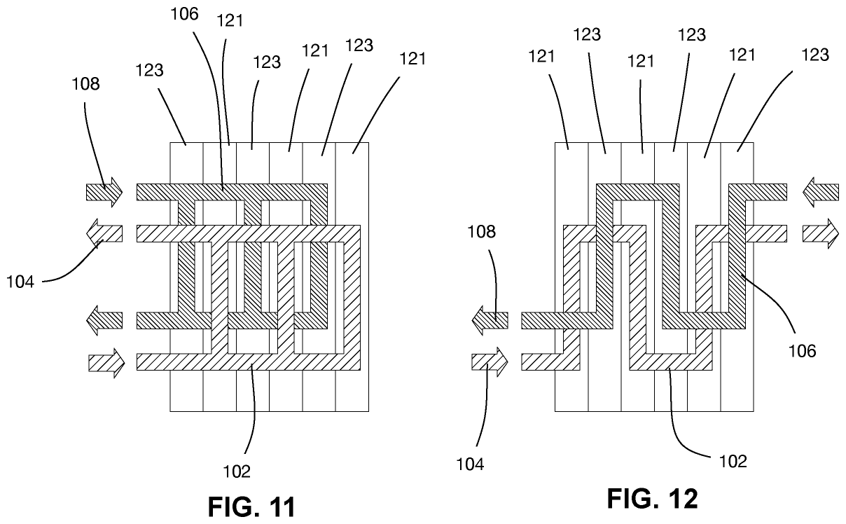

The electric vehicle 151 may further include a thermal management system 150, which is described in more detail further below in relation to FIGS. 13-22. The thermal management system 150 may include the coolant-refrigerant heat exchanger 100.

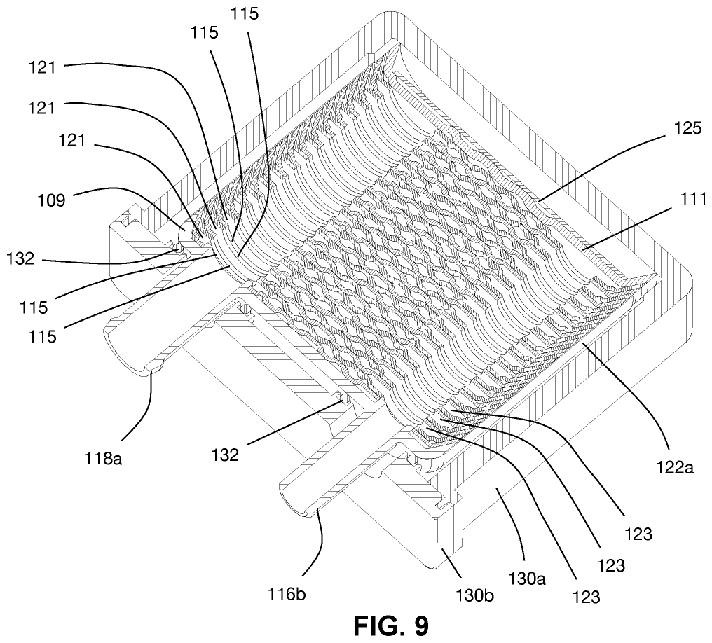

The coolant-refrigerant heat exchanger 100 includes a coolant flow path 102 (FIG. 10) for transporting coolant (represented by arrows 104 in FIG. 10) therethrough, and a refrigerant flow path 106 (FIGS. 10 and 11) for transporting refrigerant (represented by arrows 108 in FIG. 10) therethrough. The coolant flow path 102 and the refrigerant flow path 106 are positioned so as to transfer heat from one of the coolant 104 and the refrigerant 108 to the other of the coolant 104 and the refrigerant 108. In the example, shown, the coolant-refrigerant heat exchanger 100 includes a plurality of flow plates 110. Each flow plate 110 has a first face 112a and a second face 112b shown in FIGS. 7b and 9, and a peripheral edge 114 (FIG. 7b). The plurality of flow plates 110 are connected together such that the coolant flow path 102 and the refrigerant flow path 106 are defined between mutually facing ones of the faces of adjacent ones of the plurality of flow plates 110. More specifically, with reference to FIGS. 9 and 10, in the embodiment shown, the coolant flow path 102 is defined between the second face 112b of the first plate (shown at 110a) and the first face 112a of the second plate (shown at 110b), between the second face 112b of a third plate (shown at 110c) and the first face 112a of a fourth plate (shown at 110d), between the second face 112b of a fifth plate (shown at 110e) and the first face 112a of a sixth plate (shown at 110f), and so on. Analogously, the refrigerant flow path 106 is defined between the first face 112a of the second flow plate 110b and the second face 112b of the third flow plate 110c, between the first face 112a of the fourth plate (shown at 110d) and the second face 112b of the fifth flow plate 110e, and so on. In the embodiment shown, there are 32 flow plates 110 which are sealingly joined together.

The flow plates 110 may be made from any suitable material, such as, for example, aluminum. While it is known that aluminum has a higher thermal conductivity than certain materials such as stainless steel, aluminum is not the typical material used for coolant or refrigerant conduits in coolant-refrigerant heat exchangers in vehicles.

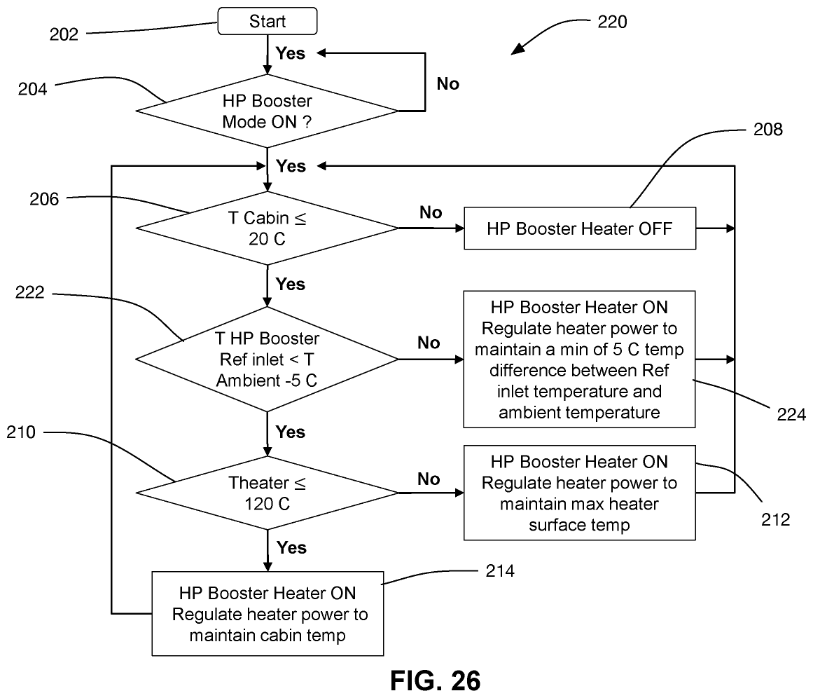

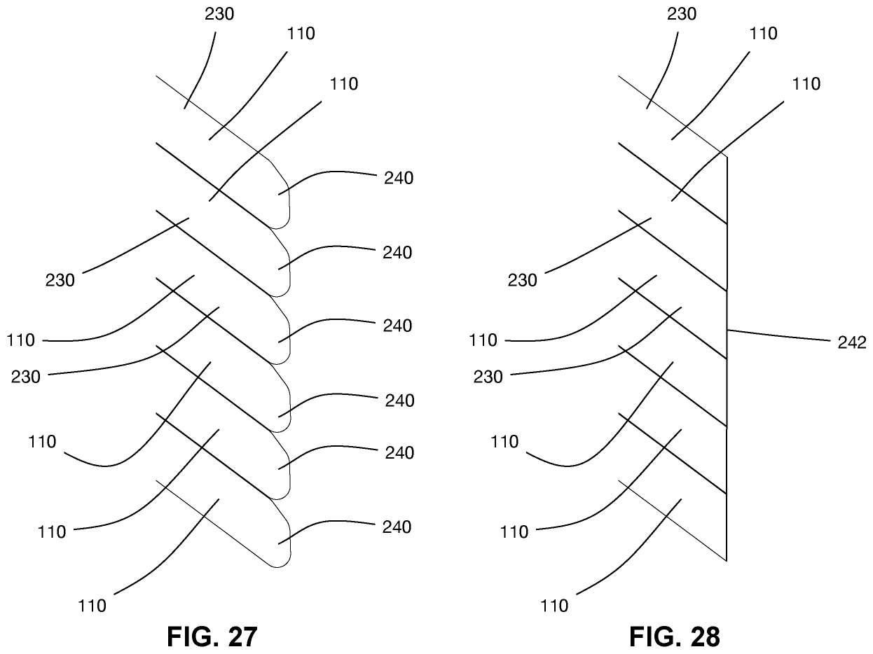

FIGS. 27 and 28 illustrate intermediate states of manufacture of the coolant-refrigerant heat exchanger 100. More specifically, the flow plates 110 each have a flange portion 230 that is used for joining the flow plates 110 together. The flange portions 230 of the flow plates 110 mate with one another. Braze material may be provided between the flange portions 230 and the flow plates 110 may then be heated to melt the braze material so as to sealingly join the flow plates 110 together. The outermost edges of the flange portions 230 are shown at 240 and have a shape that creates a space between successive ones of the flow plates 110 when they are sealingly joined together.

A subsequent state in the manufacture of the coolant-refrigerant heat exchanger 100 is shown in FIG. 28. After the flow plates 110 are sealingly joined together as shown in FIG. 27, they are processed in such a way so as to remove the portions of the outermost edges 240 so as to eliminate any spaces between the outermost edges 240, thereby generating a contiguous heat exchange surface 242. The processing of the outermost edges 240 may be by grinding, by machining, by milling or by any other suitable processing step.

Once the flow plates 110 are in the state shown in FIG. 28, the peripheral edge heater 122a may be applied to the heat exchange surface 242. By providing the contiguous heat exchange surface 242, the heat transfer from the peripheral edge heater 122a into the flow plates 110 is improved relative to if the outermost edges 240 had not been processed as described. FIG. 9 shows the heat exchange surface 242 with the peripheral edge heater 122a joined thereto. The joining of the peripheral edge heater 122a to the heat exchange surface 242 may be by any suitable means, such as by use of a double-sided tape on the mating surface of the peripheral edge heater 122a. Alternatively, in embodiments where the peripheral edge heater 122a is a film heater, the peripheral edge heater may be directly printed on the heat exchange surface 242.

As can be seen in FIG. 7A, the peripheral edge 114 of the flow plates 110 is rectangular with rounded corners (a rounded rectangle) in the embodiment shown. However, it will be understood that the peripheral edge 114 could have any other suitable shape, such as a circular shape, an elliptical shape, a regular or irregular polygonal shape with rounded corners having more or fewer than 4 sides or any other suitable shape. The shape of the peripheral edge 114 preferably has rounded corners where corners are present, however, corners that have substantially no rounding may be provided instead.

With reference to FIG. 7a, in the embodiment shown, a first end cover plate 109 is sealingly joined to a first end of the plurality of flow plates 110 and includes a refrigerant inlet 116a, a refrigerant outlet 116b, a coolant inlet 118a and a coolant outlet 118b. The first end cover plate 109 may be joined to the flow plates 110 in the same way that the flow plates 110 are joined to one another, and may be processed along with the flow plates to further form the heat exchange surface 242. A refrigerant filter 119 may be provided at the refrigerant inlet 116a to filter contaminants from the refrigerant 108 before it passes through the flow plates 110.

A second end cover plate 111 (FIG. 9) is sealingly joined to a second end of the plurality of flow plates 110. The second end cover plate 111 may be joined to the flow plates 110 in the same way that the flow plates 110 are joined to one another, and may be processed along with the flow plates to further form the heat exchange surface 242.

With reference to FIGS. 7b and 8, each of the flow plates 110 has a plurality of ridges 120 thereon on each of the first and second faces 112a and 112b, which define grooves which act as channels for the flow of refrigerant 108 or coolant 104 as the case may be. In the embodiment shown, the ridges 120 on each flow plate 110 form a pattern that alternates with the pattern of the ridges 120 on each adjacent flow plate 110. In other words, the ridges on the odd-numbered flow plates 110, (i.e., the first plate, the third plate, the fifth plate, etc.), form a pattern that alternates with the pattern on the even-numbered flow plates 110, (i.e. the second plate, the fourth plate, the sixth plate, etc.). The patterns of the ridges 120 on both the odd-numbered flow plates 110 and the even-numbered flow plates 110 may be herringbone patterns.

FIG. 9 shows a sectional view of the coolant-refrigerant heat exchanger 100. As can be seen, the flow plates 110 have first and second refrigerant pass-through apertures 113 and first and second coolant pass-through apertures 115. The space between the first flow plate 110a and the second flow plate 110b is a first coolant space 121. The space between the second flow plate 110b and the third flow plate 110c is a first refrigerant space 123. The space between the third flow plate 110c, the fourth flow plate 110d is a second coolant space 121, and so on. The space between the fourth flow plate 110d and the fifth flow plate 110e is a second refrigerant space 123. The spaces between the flow plates 110 alternate between coolant spaces 121 and refrigerant spaces 123 throughout the series of flow plates 110. As can be seen, in the region of the refrigerant pass-through apertures 113, the first flow plate 110a is sealingly engaged with the second flow plate 110b, the second flow plate 110b is spaced from the third flow plate 110c, the third flow plate 110c is sealingly engaged with the fourth flow plate 110d, and the fourth flow plate 110d is spaced from the fifth flow plate 110e, and so on. Thus, the refrigerant 108 can flow in the refrigerant spaces 123. Additionally, in the region of the coolant pass-through apertures 115, the first flow plate 110a is spaced from the second flow plate 110b, the second flow plate 110b is sealingly engaged with the third flow plate 110c, the third flow plate 110c is spaced from the fourth flow plate 110d, the fourth flow plate 110d is sealingly engaged with the fifth flow plate 110e, and so on. Thus, the coolant 104 can flow in the coolant spaces 121.

The coolant-refrigerant heat exchanger 100 further includes a secondary heater 122 that is positioned to heat both the refrigerant 108 and the coolant 104 while in the coolant-refrigerant heat exchanger 100. The secondary heater 122 may, for example, extend along the peripheral edge 114 of substantially all of the plurality of flow plates 110 so as to impart heat into each of the flow plates 110 through the height and the width of each of the flow plates 110. The secondary heater 122 may be an electrical resistance heater, such as, for example a PTC heater. Alternatively, the secondary heater 122 may be any other suitable kind of heater, such as, but not limited to, an induction heater, an infrared heater, a microwave heater, or any other kind of heater.

The secondary heater 122 may include a band heater 122a that extends around substantially the entire length of the peripheral edges 114 of the flow plates 110. Additionally, the secondary heater 122 may include a first end heater 122b that is engaged with the first flow plate 110a for imparting heat into the plurality of flow plates 110 through the thickness of the first flow plate 110a, and a second end heater 122c for imparting heat into the plurality of flow plates 110 through the thickness of the second end cover plate 111. A heat spreader plate 125 may be provided between the second end heater 122c and the second end cover plate 111.

A feature of the secondary heater 122 is that it is sized to evaporate all of the refrigerant 108 passing through the coolant-refrigerant heat exchanger 100 (i.e. all the refrigerant 108 in the refrigerant flow path 106), so as to ensure that substantially all of the refrigerant 108 can be evaporated in the coolant-refrigerant heat exchanger 100 without any heat input to the refrigerant 108 from the coolant 104 in the coolant flow path 102. In some embodiments, the secondary heater 122 is sized to superheat all the refrigerant in the refrigerant flow path 106 in order to ensure that all of the refrigerant 108 is evaporated and that substantially none of the refrigerant 108 remains in its liquid phase.

A controller 124 may be provided for controlling the operation of the secondary heater 122. Electrical connections shown at 126 and 128 are provided for providing power to the secondary heater 122 and for providing power to the controller 124.

A heat exchanger housing 130 may be provided for housing the above-described components. The housing 130 may include a first housing portion 130a and a second housing portion 130b that is sealingly connected to the first housing portion 130a. O-rings 132 may be provided for sealing around the apertures shown at 134 in the housing 130 that permit the pass-through of the coolant inlet 118a, the coolant outlet 118b, the refrigerant inlet 116a and the refrigerant outlet 116b. Another seal member 136 is provided between the refrigerant filter 119 and the refrigerant inlet 116a.

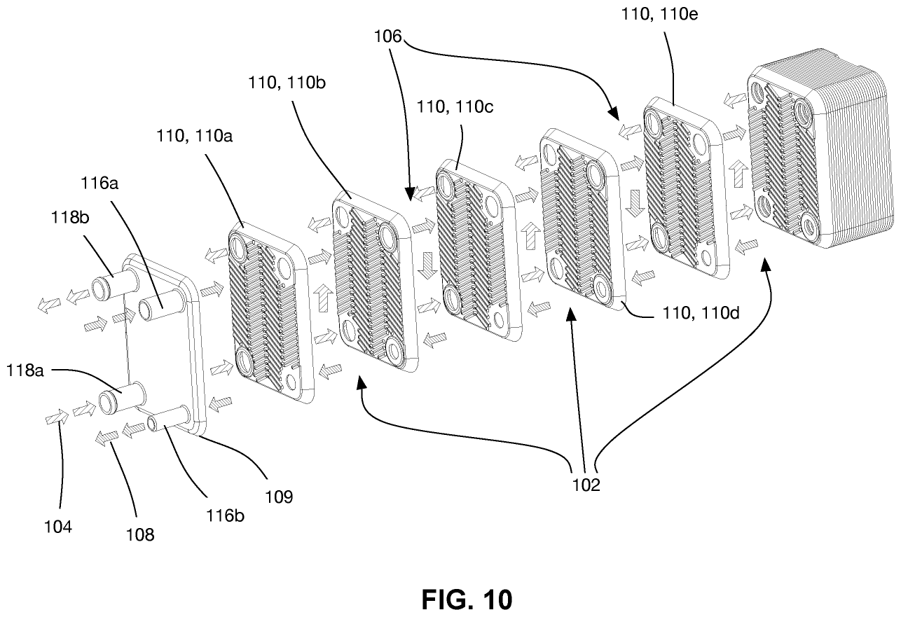

FIG. 11 shows a schematic representation of the coolant spaces 121 and the refrigerant spaces 123 and the routing of the coolant flow path 102 and the refrigerant flow path 106 in the embodiment shown in FIGS. 6-10. As can be seen, the coolant 104 travels from the coolant inlet 118a, through to the coolant spaces 121 and then along the coolant spaces 121 and back to the coolant outlet 118b. Similarly, the refrigerant 108 travels from the refrigerant inlet 116a, through to the refrigerant spaces 123 and then along the refrigerant spaces 123 and back to the refrigerant outlet 116b. Thus, in the embodiment shown in FIG. 11 (and FIGS. 6-10), the coolant outlet 118b and the refrigerant outlet 116b are both at the same end of the plurality of flow plates 110 as the coolant inlet 118a and the refrigerant inlet 116a. In an alternative embodiment shown in FIG. 12, the first end cover plate 109 and the second end cover plate 111 are configured to each have one inlet and one outlet. For example, the first end cover plate 109 may have the coolant inlet 118a and the refrigerant outlet 116b, and the second end cover plate 111 may have the coolant outlet 118b and the refrigerant inlet 116a. Thus, the coolant 104 may flow across the flow plates 110 from the first end to the second end, and the refrigerant 108 may flow across the flow plates 110 from the second end to the first end.

Regardless of whether the coolant flow path 102 and the refrigerant flow path 106 are as shown in FIGS. 6-11, or are as shown in FIG. 12, the coolant flow path 102 and the refrigerant flow path 106 may be said to be positioned in order to transfer heat from one of the coolant 104 and the refrigerant 108 to the other of the coolant 104 and the refrigerant 108, and the secondary heater 122 may be said to be positioned to heat both the refrigerant 108 and the coolant 104 in the coolant-refrigerant heat exchanger 100.

Several advantageous features of the coolant-refrigerant heat exchanger 100 are described as follows: The coolant-refrigerant heat exchanger 100 includes a plurality of flow plates 110. It has been found to be effective to provide the secondary heater 122 in the form of a band heater 122a that extends along substantially all of the peripheral edges of the flow plates 110, and also to provide the first end heater 122b, and to provide the second end heater 122c, such that heat is transferred through the height, the width, and through the thickness of the flow plates 110. The peripheral edge heater 122a and the first and second end heaters 122b and 122c may be solid elements formed from sheet material that is joined to the flow plates 110 or to the first and second end cover plates 109 and 111 respectively in any suitable way such as by a suitable adhesive. In some embodiments, one or more of the peripheral edge heater 122a and the first and second end heaters may be in the form of a film heater that is printed directly onto the surface on which it is intended to transfer heat to.

### Description of Layout of Thermal Management System Incorporating the Novel Coolant-Refrigerant Heat Exchanger

Reference is made to FIG. 13, which shows a thermal management system 150 for an electric vehicle, in accordance with an embodiment of the present disclosure. The electric vehicle is shown at 151 in FIG. 23.

The thermal management system 150 may have a similar layout to the thermal management system 50 shown in FIG. 5, and may have a refrigerant system 152 and a coolant system 154. Some differences between the thermal management system 150 and the thermal management system 50 are described as follows. One difference is that the high voltage heater 71 and its associated coolant conduit of FIG. 5 are not necessary and are omitted from the thermal management system 150. Additionally, the coolant system 154 includes a battery loop 154a and a motor loop 154b, which are connected to one another by a first transfer conduit 156 and a second transfer conduit 158. The coolant system 154 further includes an additional 3-way valve relative to the coolant system 54 of the thermal management system 50. Thus, the coolant system 154 has a first 3-way valve 160, a second 3-way valve 162 and a third 3-way valve 164, and further has a battery loop pump 166, and a motor loop pump 168. Additionally, the coolant system 154 further includes a coolant check valve 169 on the second transfer conduit 157. Additionally, the coolant system 154 includes a battery loop bypass conduit 158 and a motor loop bypass conduit 159, which are not present in the coolant system 54. The arrangement of the refrigerant system 152 may be similar to that of the refrigerant system 52. While specific configurations for the coolant system 154 and the refrigerant system 152 are shown and while specific types of valves (e.g. on-off type control valves, 3-way valves, and check valves) are shown, it will be noted that the coolant system 154 and the refrigerant system may be configured differently. As a simple example, the 3 way valves 160, 162 and 164 could be replaced with a plurality of on-off type valves. Another simple example is that the check valves in both the refrigerant and coolant systems 154 and 152 could also be replaced with on-off type control valves. Additionally, the control valves V1, V2, V3 and V4 and their associated refrigerant conduits could be replaced by a different arrangement of conduits, with a different number of valves including for example one or more 3-way valves.

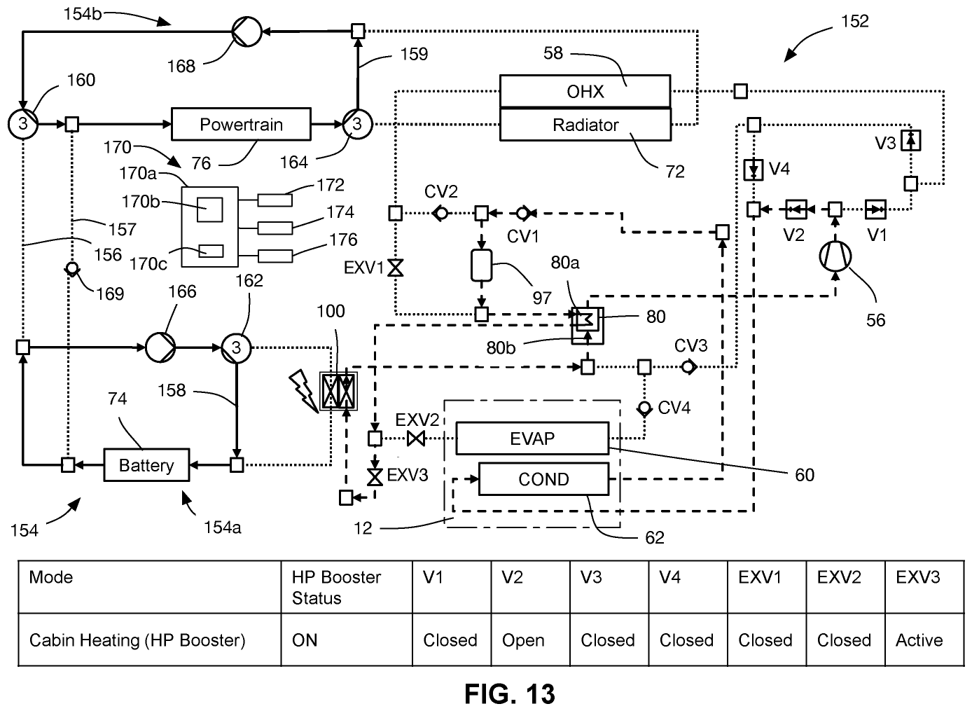

A control system, shown at 170, may be provided for controlling the operation of the thermal management system 150. The control system 170 may include a PCB (printed circuit board) 170a on which there is a processor 170b and a memory 170c. The control system 170 may be said to be operatively connected to the control valves V1, V2, V3 and V4, the expansion valves EXV1, EXV2 and EXV3, the 3-way valves 160, 162 and 164, and the secondary heater 122 in order to control their operation. Lines representing wires to show the connection between the PCB 170a and the aforementioned valves and secondary heater are not shown in FIG. 13 so as not to render these figures more difficult to understand. Furthermore, the control system 170 may include several sensors such as a cabin temperature sensor 172, a refrigerant temperature sensor 174 at the refrigerant inlet 116a of the coolant-refrigerant heat exchanger 100, and a secondary heater temperature sensor 176 which are all connected to the PCB 170a in order to transmit signals to the processor 170b related to the air temperature of the passenger cabin 12, the refrigerant temperature at the refrigerant inlet 116a of the coolant-refrigerant heat exchanger 100 and the temperature of the secondary heater 122, respectively. The control system 170 is shown in FIG. 13, but is omitted from FIGS. 14-22 for simplicity.

It will be noted that the control system 170 need not include only the single PCB 170a, the processor 170b and the memory 170c. It is alternatively possible for the control system 170 to include a plurality of PCBs at various locations in the electric vehicle 151, each of which has one or more processors and memory. For example, the PCB 170a may be only a part of the control system 170, and may be part of an ECM (electronic control module) for the electric vehicle 151 that controls the operation of many subsystems in the electric vehicle 151. The control system 170 may further include the controller 124 in the coolant-refrigerant heat exchanger 100. Communication between the PCB 170a and the controller 124 may be via a wired connection or may occur via a wireless connection.

Furthermore, it is not necessary for any of the temperature sensors 172, 174 and 176 to be directed connected to or to directly communicate with, the PCB 170a. For example, the secondary heater temperature sensor 176 may communicate directly with the controller 124, which in turn, may transmit the information to the PCB 170a.

A significant difference between the thermal management system 150 and the thermal management system 50 is that the thermal management system 150 includes the coolant-refrigerant heat exchanger 100 instead of the coolant-refrigerant heat exchanger 78.

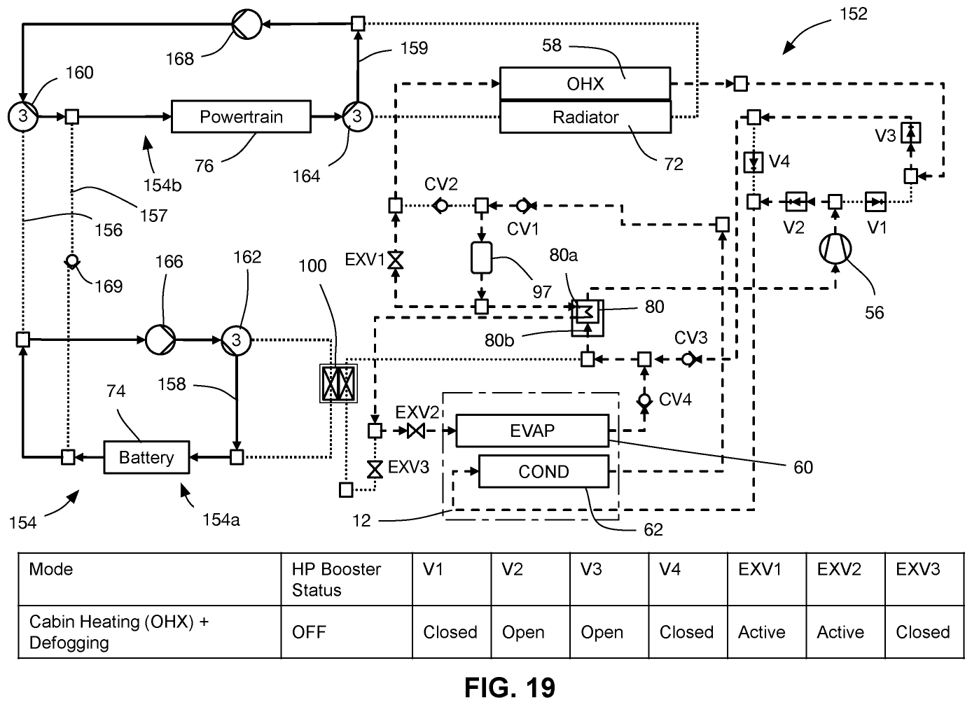

FIGS. 13, 14, 15, 16, 17, 18 and 19 show examples of modes of operation for the thermal management system 150 where the passenger cabin 12 is being heated to some extent. FIGS. 20, 21 and 22 show modes of operation for the thermal management system 150 where the passenger cabin 12 is being cooled to some extent or is not being heated. In FIGS. 13-22, when there is a small lightning bolt shown next to the coolant-refrigerant heat exchanger 100, it is an indication that the secondary heater 122 is on, and when there is no small lightning bolt next to the coolant-refrigerant heat exchanger 100, it is an indication that the secondary heater 122 is off. In each of FIGS. 13-22, a table is provided, which gives an indication of which valves are open or closed, as well as the state of the secondary heater 122 (referred to in the figure tables as ‘HP Booster’). The positions of the 3-way valves 160, 162, and 164 in the coolant system 154 in each of the figures is shown graphically in the figures.

In FIGS. 13-22, the solid lines represent conduits in which there is coolant flow, and the dashed lines represent conduits in which there is refrigerant flow. The lines which are made up of small square dots represent coolant conduits in which there is no coolant flow, and the lines which are made up of small circular dots represent refrigerant conduits in which there is no refrigerant flow.

### Descriptions of Various Heating Modes

Description of Thermal Management System in Cabin Heating Mode with the Secondary Heater

FIG. 13 shows the thermal management system 150 in a cabin heating mode using the secondary heater 122. In this mode, the control valves V1, V3, and V4 are closed, and the control valve V2 is open, and the expansion valves EXV1 and EXV2 are closed and the expansion valve EXV3 is open.

The mode shown in FIG. 13 may be used at vehicle startup in situations where the ambient temperature is below −15 degrees Celsius. In such situations, it is desirable to operate the refrigerant system 152 so as to heat the passenger cabin 12. Accordingly, the refrigerant 108 will flow through the interior condenser 62 in order to heat the interior air 24 of the passenger cabin 12. However, operation of the outside heat exchanger 58 as an evaporator may not be desirable, as there is a risk, depending on the level of humidity in the ambient air 22, of ice forming on the outside heat exchanger 58 as heat is drawn from the ambient air 22 into the outside heat exchanger 58, which would hamper its operation.

Accordingly, it is desirable to use the coolant-refrigerant heat exchanger 100 as the evaporator. However, the coolant 104 is below −15 degrees Celsius, and neither the traction battery 74 nor the traction motor 76 are sufficiently warm to provide sufficient heat to the coolant 104 for use in the coolant-refrigerant heat exchanger 100 to drive evaporation of the refrigerant 108. Furthermore, the 3-way valves 160 and 162 may be positioned to isolate the battery loop 154a from the motor loop 154b, and to bypass the coolant-refrigerant heat exchanger 100 in order to permit the traction battery 74 to warm up to its optimal operating temperature quickly.

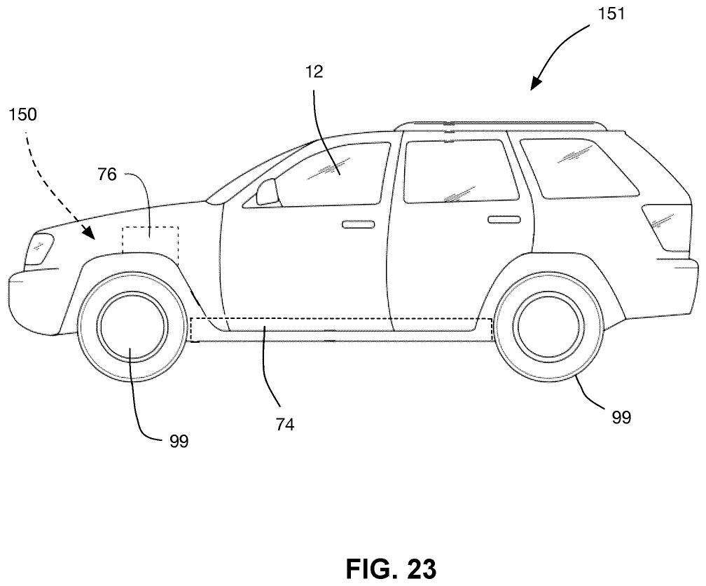

Furthermore, in some situations the ambient temperature may be sufficiently low that the pressure of the refrigerant 108 is less than 1 atmosphere. For example, if one examines the pressure-enthalpy chart shown in FIG. 24, which relates to the refrigerant 108 used in the thermal management system 150, it can be seen that, when the temperature of the refrigerant is below approximately −30 degrees Celsius, the pressure of the refrigerant 108 drops below 1 atmosphere. As a result, during operation of the compressor 56 in such an environment, it is possible to draw in contaminants into the refrigerant system 152 since the pressure at the inlet of the compressor 56 is less than the ambient pressure outside of the refrigerant system 152. Such contaminants can include particulate, moisture, or any other types of contaminants. Such contaminants can be harmful to the compressor 56 and can reduce the performance of the refrigerant system in any case.

In this situation, the control system 170 operates the coolant-refrigerant heat exchanger 100 in a secondary-heat-only mode in which the secondary heater 122 evaporates substantially all the refrigerant 108 in the refrigerant flow path 106 without any heat input from the coolant 104 in the coolant flow path 102. In some embodiments, the secondary heater 122 is heated sufficiently to superheat the refrigerant 108 in order to ensure that substantially all of the refrigerant 108 is evaporated and that substantially none of the refrigerant 108 remains in its liquid phase.

Thus, by providing the secondary heater 122 (FIGS. 7b, 8), a sufficient amount of heat can be imparted to the refrigerant 108 in the coolant-refrigerant heat exchanger 100 to raise the temperature of the refrigerant 108 to above the threshold temperature at which the refrigerant 108 has a pressure of 1 atmosphere.

The mode of operation shown in FIG. 13 is just an example of a secondary-heat-only mode for the thermal management system 150, in which the secondary heater 122 evaporates the refrigerant 108 in the refrigerant flow path 106 without any heat input from the coolant 104 in the coolant flow path 102. When the control system 170 operates the thermal management system 150 in the mode shown in FIG. 13, the control system 170 may be said to be operating the coolant-refrigerant heat exchanger 100, and may be said to programmed to operate the coolant-refrigerant heat exchanger 100, in a secondary-heat-only mode in which the secondary heater 122 evaporates the refrigerant 108 in the refrigerant flow path 106 without any heat input from the coolant 104 in the coolant flow path 102.

### Description of Modified Pressure-Enthalpy Chart

With reference to FIG. 24, the dashed line curve shown at 180 represents the changes in the properties of the refrigerant 108 as it passes through the refrigeration system 152 shown in FIG. 13. Point 182 represents the properties of the refrigerant immediately upstream of the compressor 14 after the refrigerant 108 has been heated by the secondary heater 122 for a period of time. As can be seen, the temperature of the refrigerant 108 at point 182 is above the aforementioned threshold temperature. Accordingly, the pressure of the refrigerant 108 at point 182 is above 1 atmosphere, thereby preventing the ingress of contaminants into the refrigerant system 152. Curve segment 180a is representative of the change in the properties of the refrigerant 108 due to operation of the compressor 56. Point 184 is representative of the properties of the refrigerant 108 downstream of the compressor 56 and upstream from the interior condenser 62. As can be seen, the pressure and the temperature of the refrigerant 108 both increase between point 182 and point 184.

Curve segment 180b is representative of the change in the properties of the refrigerant 108 due to operation of the interior condenser 62. Point 186 is representative of the properties of the refrigerant 108 immediately downstream of the interior condenser 62 (and therefore upstream from the expansion valve (which is the expansion valve EXV3 when the thermal management system 150 is operated in the mode shown in FIG. 13)). As can be seen, the temperature of the refrigerant 108 decreases and then remains constant during the phase change that occurs in the interior condenser 62.

Curve segment 180c is representative of the change in the properties of the refrigerant 108 due to the expansion valve (e.g. expansion valve EXV3 when the thermal management system 150 is operated in the mode shown in FIG. 13). Point 188 is representative of the properties of the refrigerant 108 immediately downstream of the expansion valve and therefore upstream from the coolant-refrigerant heat exchanger 100). As can be seen, the pressure and temperature of the refrigerant 108 decrease as a result of passing through the expansion valve.

Curve segment 30d is representative of the change in the properties of the refrigerant 108 due to passage through the coolant-refrigerant heat exchanger 100. After passing through the coolant-refrigerant heat exchanger 100, the refrigerant 108 returns to point 182, which is representative of the properties of the refrigerant 108 immediately downstream of the coolant-refrigerant heat exchanger 100 and therefore upstream of the compressor 56. As can be seen, the pressure and the temperature remain substantially constant in the coolant-refrigerant heat exchanger 100 until the refrigerant reaches the boundary line shown at 189, representing the boundary between the liquid phase and the gas phase. As shown in FIG. 24, the secondary heater 122 transfers to the refrigerant 108 sufficient heat superheat the refrigerant 108 by some amount after all of the refrigerant has been evaporated in the coolant-refrigerant heat exchanger 100, thereby driving a small increase in temperature of the refrigerant 108. This ensures that all of the refrigerant leaves the coolant-refrigerant heat exchanger 100 as a gas.

When operating in the mode shown in FIG. 13, it will be noted that the curve 180 is the curve for the refrigerant 108 once the refrigerant 108 has been heated already by the coolant-refrigerant heat exchanger 100 and is in a steady cycle after the aforementioned threshold temperature. To reach this steady cycle from a state where the refrigerant 108 is initially at a temperature that is below the aforementioned threshold temperature, the thermal management system 150 may be operated for some period of time in the mode shown in FIG. 13, in order to circulate refrigerant 108 through the coolant-refrigerant heat exchanger 100 (and the compressor 56, the interior condenser 62 and the expansion valve EXV3) in order to progressively heat the refrigerant 108 up. At some point during the progressive heating of the refrigerant 108, the refrigerant 108 will progress from a state where the refrigerant 108, at the point just upstream from the compressor 56, is at a pressure that is less than 1 atmosphere, to a state where the refrigerant 108, at the point just upstream from the compressor 56, is at a pressure that is greater than 1 atmosphere. The aforementioned transition from a state where the pressure of the refrigerant 108 is less than 1 atmosphere to a state where it is greater than 1 atmosphere, upstream from the compressor 56, is represented graphically in FIG. 24. As can be seen in FIG. 24, there is a dashed line curve shown at 190, which represents the changes in properties (temperature and pressure) of the refrigerant 108, that would take place if the secondary heater 122 were not present. Thus, upon vehicle startup at a cold ambient temperature, the initial state of the refrigerant 108 at the inlet to the compressor 56 is shown at point 192. Initially, when the refrigerant system 152 is operated, the compressor 56 brings the refrigerant 108 to the point shown at 194 (the change in properties represented by curve segment 190a). The refrigerant 108 then passes through the condenser 162, where the refrigerant 108 is lowered in temperature and condensed, represented by curve segment 190b. Downstream from the interior condenser 62, the refrigerant properties are shown at point 196. The refrigerant 108 then passes through the expansion valve (e.g. expansion valve EXV3) where its pressure is reduced, thereby reducing its temperature, represented by curve segment 190c. Downstream from the expansion valve, the refrigerant properties are shown at point 198. The point 198, while shown at the same pressure as point 192, need not be precisely at the same pressure as the point 192. The refrigerant 108 then passes through the coolant-refrigerant heat exchanger 100 where it undergoes a phase change and is superheated by some amount, thereby raising its temperature by some amount, and thereby also increasing its pressure. Curve segment 190d represents the change in properties of the refrigerant 108 that occur during the phase change (i.e. the evaporation) that occurs in the coolant-refrigerant heat exchanger 100. The superheating of the refrigerant 108 in the coolant-refrigerant heat exchanger 100 after the phase change is complete in the coolant-refrigerant heat exchanger 100 is represented by curve segment 199.

If the secondary heater 122 were sufficiently powerful, a single cycle through the refrigerant system 152 could bring the refrigerant 108 to the state represented by point 182, when the refrigerant 108 exits from the coolant-refrigerant heat exchanger 100 (as represented by the curve segment 199 as shown in FIG. 24. However, the jump in temperature and pressure for the refrigerant 108 when passing through the coolant-refrigerant heat exchanger 108 may be smaller than that shown in FIG. 24. In other words, the length of curve segment 199 maybe smaller than that shown in FIG. 24. However, over time, after a number of cycles (i.e. after a number of passes theough the refrigerant system 152), the temperature of the refrigerant 108 at the inlet to the compressor 56 will progressively increase, until, eventually, the pressure of the refrigerant 108 at the inlet of the compressor 56 increases to above 1 atmosphere. In other words, eventually, there will be a point where the refrigerant 108 will have a pressure that is below one atmosphere, and the refrigerant 108 will complete a pass through the refrigerant system (i.e. through the compressor 56, the interior condenser 62, the expansion valve EXV3 and the coolant-refrigerant heat exchanger 100), whereby the superheating that occurs in the coolant-refrigerant heat exchanger 100 will result in the refrigerant 108 exiting the coolant-refrigerant heat exchanger 100 with a pressure that is greater than 1 atmosphere. Worded another way, this transition from a pressure of below 1 atmosphere to above 1 atmosphere may be said to occur by carrying out the following method of operating the refrigerant system 152, whereby the method includes:
a) compressing the refrigerant 108 in the refrigerant system 152, thereby bringing the refrigerant 108 from a first temperature and a first pressure (point 192) to a second temperature and a second pressure (point 194), wherein the first temperature is sufficiently low that the first pressure is less than 1 atmosphere;
b) condensing the refrigerant 108 after step a), thereby bringing the refrigerant 108 from the second temperature and the second pressure (point 194) to a third temperature and a third pressure (point 196);
c) passing the refrigerant 108 through an expansion valve after step b), thereby bringing the refrigerant 108 from the third temperature and the third pressure (point 196) to a fourth temperature and a fourth pressure (point 198);
d) evaporating the refrigerant 108 after step c), in an evaporator, which is the coolant-refrigerant heat exchanger 100, wherein the coolant-refrigerant heat exchanger 100 is positioned to transfer heat between the coolant 104 in the coolant system 154 and the refrigerant 108, wherein the evaporating is carried out by heating the refrigerant 108 using the secondary heater 122 and without heating the refrigerant 108 using the coolant-refrigerant heat exchanger 100, to bring the refrigerant 108 from the fourth temperature and the fourth pressure (point 198) to a fifth temperature and a fifth pressure (point 182), wherein the fifth temperature is sufficiently high that the fifth pressure is greater than 1 atmosphere; and
e) compressing the refrigerant 108 after step d), thereby bringing the refrigerant 108 from the fifth temperature and the fifth pressure (point 182) to beyond the fifth temperature and beyond the fifth pressure (point 184).

While it is advantageous to increase the pressure of the refrigerant 108 to be above 1 atmosphere from a pressure that is less than 1 atmosphere, it will also be noted that the increase in the pressure of the refrigerant 108 in any case, even if it remains below 1 atmosphere may still be advantageous since it increases the density and therefore the mass flow rate of the refrigerant 108, thereby increasing the effectiveness of the refrigerant system 152 in its ability to perform heat exchange. Thus, the above described method can be more broadly worded, such that the first pressure of the refrigerant 108 may be any suitable pressure, which may be above or below one atmosphere, and such that the fifth pressure (point 182) may be any suitable pressure as long as it is greater than the first pressure (point 192) of the refrigerant 108.

### Description of First Algorithm for Controlling Operation of the Secondary Heater

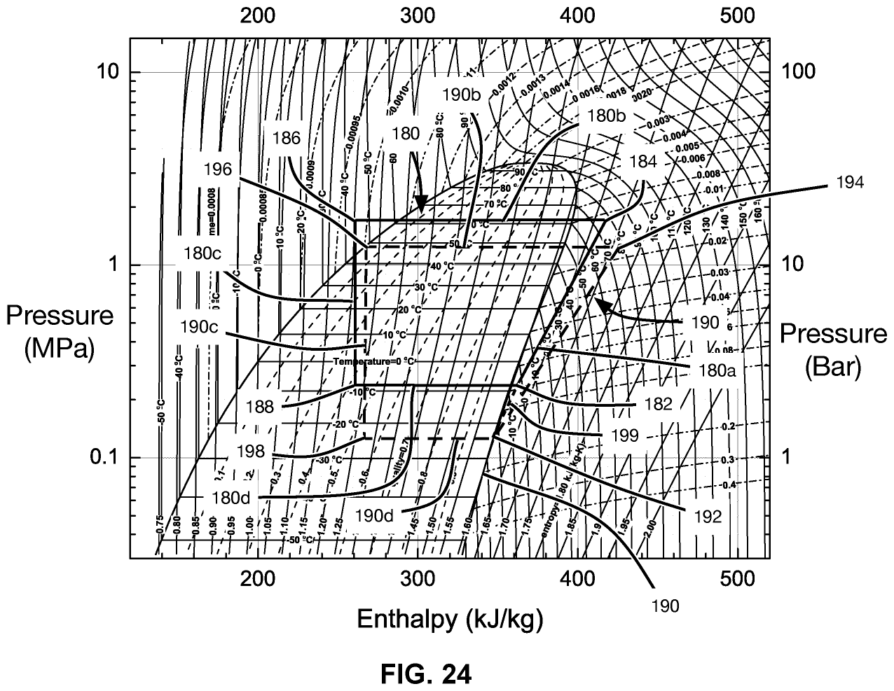

The secondary heater 122 may be controlled by the control system 170 using any suitable algorithm. For example, a suitable method for controlling the secondary heater 122 is shown at 200 in FIG. 25. The method 200 starts at 202. At step 204, it is determined whether the thermal management system 150 is in a mode in which the secondary heater 122 would be used (such as, for example the mode shown in FIG. 13). If not, control loops back to this determination step 204 until such time that the thermal management system 150 is in a suitable mode. Once it is determined that the thermal management system 100 is in a suitable mode, step 206 is carried out, which is to determine if the temperature of the passenger cabin 12 is less than whatever temperature the vehicle occupants have set it to (referred to herein as the target cabin temperature). This step involves the control system 170 receiving data from the cabin temperature sensor 172. If the passenger cabin 12 is already at or is greater than its target cabin temperature, then the control system 170 sets the secondary heater 122 to ‘off’ at step 208. The target cabin temperature may be any suitable value, such as 20 degrees Celsius as shown in the step 206. If the passenger cabin 12 is less than its target cabin temperature, then step 210 is carried out, which is to determine if the temperature of the secondary heater 122 is less than an upper threshold temperature (which is a maximum temperature that the secondary heater 122 is permitted to operate at). This step involves the control system 170 receiving data from the secondary heater temperature sensor 176. The upper threshold temperature may be any suitable temperature such as, for example, 120 degrees Celsius. If the secondary heater 122 is already at or is greater than its upper threshold temperature, then the control system 170 carries out step 212, which is to set the secondary heater 122 to ‘on’ at a power level that is lower than whatever power level it was on immediately prior to step 212 being carried out. After step 210 or step 212 being carried out, control is passed back to step 206. If the secondary heater 122 is determined to be at less than its upper threshold temperature, then step 214 is carried out, which is to set the secondary heater 122 to ‘on’ at any suitable power level, such as full power, and to pass control back to step 206.

Description of Thermal Management System in Cabin Heating Mode with the Secondary Heater and with the Outside Heat Exchanger

This mode is shown in FIG. 14. In this mode, the control valves V2 and V3 are open and the control valves V1 and V4 are closed. The expansion valves EXV1 and EXV3 are active (on) and the expansion valve EXV2 is closed (off). The secondary heater 122 is on.

In this mode, the refrigerant 108 is directed from the compressor 56, through the control valve V2, through the interior condenser 62, and through the check valve CV1. A first portion of the refrigerant flow passes through the rrhe 80, through the expansion valve EXV3, through the coolant-refrigerant heat exchanger 100, back through the rrhe 80, and back to the compressor 56. A second portion of the refrigerant flow passes through the expansion valve EXV1, through the outside heat exchanger 58, through control valve V3, through check valve CV3, through the rrhe 80, and back to the compressor 56.

In this mode, the coolant system 154 is shown as having the first, second and third 3-way valves 160, 162 and 164 positioned so as to isolate the battery loop 154a and the motor loop 156 from each other, and to bypass the coolant-refrigerant heat exchanger 100 on the battery loop 154a and the radiator 72 on the motor loop 154b.

This mode may be used during vehicle startup when ambient temperatures outside the electric vehicle 151 are in the range of about −20 degrees Celsius to about −7 degrees Celsius. In this mode, the coolant-refrigerant heat exchanger 100 (along with the secondary heater 122) and the outside heat exchanger 58 are both used as evaporators to evaporate a portion of the refrigerant, and the interior condenser 62 is used to heat the interior air 24 in the passenger cabin 12. This mode may be used when some heat from the secondary heater 122 is desired to help bring up the temperature of the refrigerant 108, but when some heat can be imparted to the refrigerant from the outside air 22 via the outside heat exchanger 58.

It will be noted that, in the mode shown in FIG. 14, the coolant-refrigerant heat exchanger 100 is operated by the control system 170 to evaporate the refrigerant in the refrigerant flow path 106 using at least some heat input from the coolant in the coolant flow path 102. Thus, the control system 170 may be said to be programmed to operate the coolant-refrigerant heat exchanger 100 in a heat-scavenging mode in which at least some heat from the coolant 104 in the coolant flow path 102 evaporates the refrigerant 108 in the refrigerant flow path 106. It is possible in some embodiments to operate the chre 100 in a heat-scavenging mode in which the heat from the refrigerant 108 in the refrigerant flow path 106 is evaporated solely by heat input from the coolant 104 in the coolant flow path 102.

Description of Second Algorithm for Controlling Operation of the Secondary Heater when Outside Heat Exchanger is Also being Used

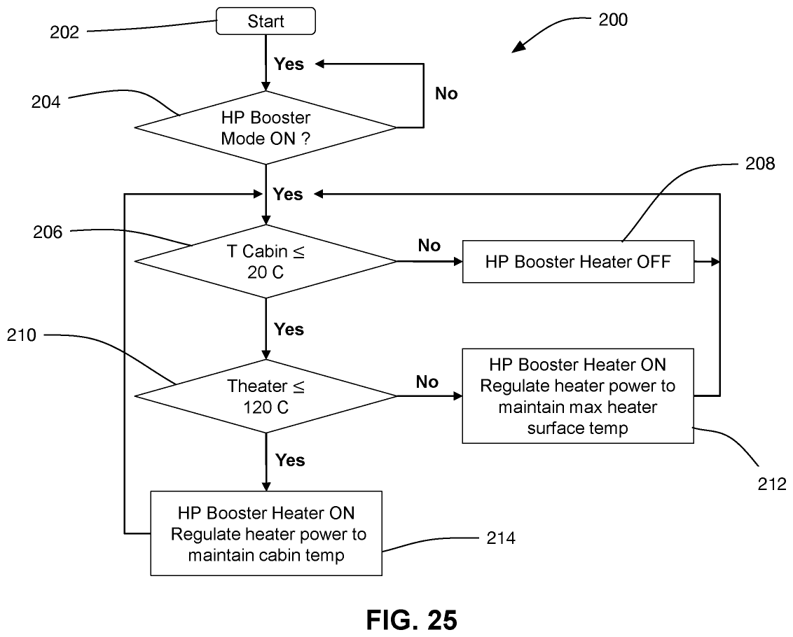

The secondary heater 122 may be controlled by the control system 170 using a method, shown at 220 in FIG. 26. The method 220 may be similar to the method 200 shown in FIG. 25, and may thus start at 202 and may include all of steps 204, 206, 208, 210, 212 and 214, but further includes additional steps, as follows. Step 222 is carried out between steps 206 and 210. In other words, if it is determined in step 206 that the passenger cabin 12 is less than its target cabin temperature, then step 222 is carried out, in which it is determined whether the temperature of the refrigerant 108 at the refrigerant inlet 116a of the coolant-refrigerant heat exchanger 100 is less than the ambient temperature minus 5 degrees (Celsius). If it is determined that the refrigerant inlet temperature at the refrigerant inlet 116a of the coolant-refrigerant heat exchanger 100 is not less than the ambient temperature minus 5 degrees (Celsius), then step 224 is carried out in which the secondary heater 122 is set to ‘on’, but is operated at a reduced power level so as to reduce the temperature of the refrigerant 108 at the refrigerant inlet 116a so as to attempt to bring the temperature of the refrigerant to less than the ambient temperature minus 5 degrees (Celsius). A reason for this is that the operation of the outside heat exchanger 58 depends on there being a temperature differential between the refrigerant in the outside heat exchanger 58 and the outside air 22. If there is not a sufficient temperature differential therebetween, the performance of the outside heat exchanger 58 in evaporating the refrigerant 108 will be compromised. Accordingly, it is desirable to maintain a selected minimum temperature differential between the refrigerant temperature and the ambient air temperature. In the above description related to steps 222 and 224, 5 degrees Celsius was used as an example of the minimum temperature differential. However, it will be understood by one skilled in the art that this value may be higher or lower, based on the specifical design goals for the electric vehicle 151. After carryout out step 224, control is passed back to step 206.

If it is determined that the refrigerant inlet temperature at the refrigerant inlet 116a of the coolant-refrigerant heat exchanger 100 is less than the ambient temperature minus 5 degrees (Celsius), then step 210 is carried out.

Description of Thermal Management System in Cabin Heating Mode with Secondary Heater and with Outside Heat Exchanger

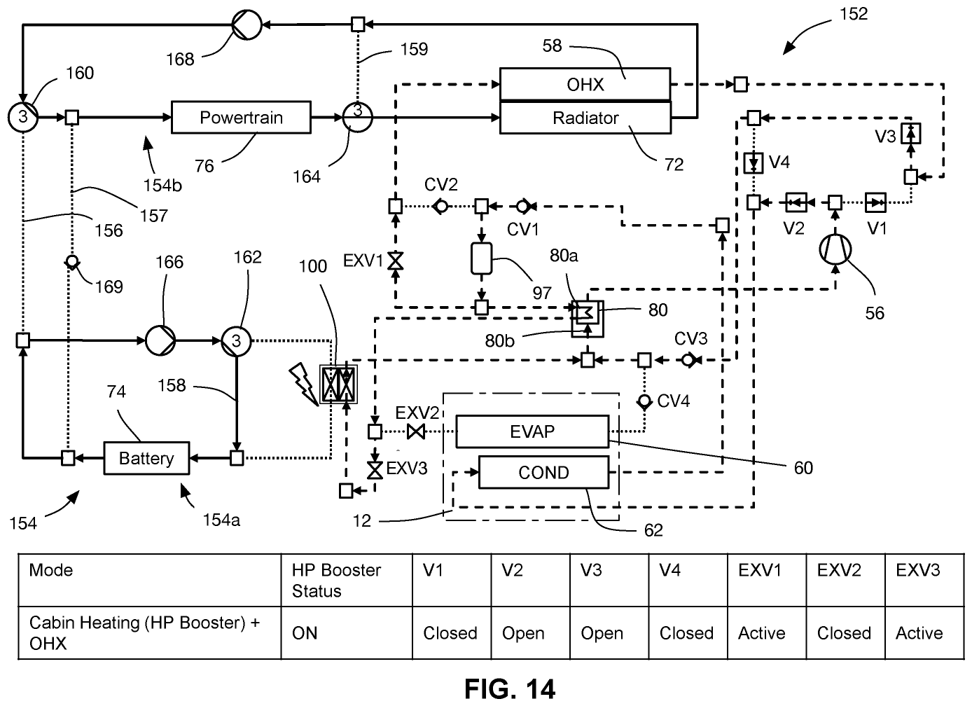

This mode is shown in FIG. 15. In this mode, the control valve V2 is open and the control valves V1, V3 and V4 are closed. The expansion valve EXV3 is active (on) and the expansion valves EXV1 and EXV2 are closed (off). The secondary heater 122 is on.

In this mode, the refrigerant 108 is directed from the compressor 56, through the control valve V2, through the interior condenser 62, through the check valve CV1, through the rrhe 80, through the expansion valve EXV3, through the coolant-refrigerant heat exchanger 100, back through the rrhe 80, and back to the compressor 56, in similar manner to the operation of the refrigerant system 152 in the mode shown in FIG. 13. A difference in the mode shown in FIG. 15, however, is that the coolant 104 is circulated through the coolant-refrigerant heat exchanger 100, so as to heat the refrigerant 108 in the coolant-refrigerant heat exchanger 100 using waste heat from the coolant 104.

This mode may be used when ambient temperatures outside the electric vehicle 151 are in the range of about −20 degrees Celsius to about −7 degrees Celsius, but when the electric vehicle was on plug (i.e. was plugged in to a power source) and the traction battery 74 is preheated already. In this mode, the coolant-refrigerant heat exchanger 100 (along with the secondary heater 122) is used as an evaporator to evaporate the refrigerant, and the interior condenser 62 is used to heat the interior air 24 in the passenger cabin 12. This mode may be used when some heat from the secondary heater 122 is desired to help bring up the temperature of the refrigerant 108, but when some heat can nonetheless be imparted to the refrigerant from the outside air 22 via the coolant since the heat in the coolant is not needed to bring the traction battery 74 up to its optimal temperature range.

Description of Thermal Management System in Cabin Heating Mode with Secondary Heater and with Waste Heat Scavenging from Coolant

This mode is shown in FIG. 15. In this mode, the control valve V2 is open and the control valves V1, V3 and V4 are closed. The expansion valve EXV3 is active (on) and the expansion valves EXV1 and EXV2 are closed (off). The secondary heater 122 is on.

In this mode, the refrigerant 108 is directed from the compressor 56, through the control valve V2, through the interior condenser 62, through the check valve CV1, through the rrhe 80, through the expansion valve EXV3, through the coolant-refrigerant heat exchanger 100, back through the rrhe 80, and back to the compressor 56, in similar manner to the operation of the refrigerant system 152 in the mode shown in FIG. 13. A difference in the mode shown in FIG. 15, however, is that the coolant 104 is circulated through the coolant-refrigerant heat exchanger 100, so as to heat the refrigerant 108 in the coolant-refrigerant heat exchanger 100 using waste heat from the coolant 104.

This mode may be used on a very cold day (e.g. below −15 degrees Celsius) when the ambient air is too cold to be suitable for use of the outside heat exchanger 58, and the electric vehicle 151 has been driven for a while, and as a result the traction battery 74 and the coolant 104 are warmer than the outside ambient air. In this mode, the coolant-refrigerant heat exchanger 100 (along with the secondary heater 122) is used as an evaporator to evaporate the refrigerant, and the interior condenser 62 is used to heat the interior air 24 in the passenger cabin 12. The coolant 104 in the coolant system 154 is circulated through the coolant-refrigerant heat exchanger 100 in order to impart heat to the refrigerant 108, to supplement the heat that is imparted by the secondary heater 122 to the refrigerant 108. This mode is advantageous in that the use of the waste heat from the coolant 104 and the traction battery 74 can allow the control system 170 to reduce the power consumed by the secondary heater 122, or alternatively, to reduce the amount of time needed to bring the refrigerant 108 up to a target temperature.

Description of Thermal Management System in Battery Pre-Heat Mode with Secondary Heater

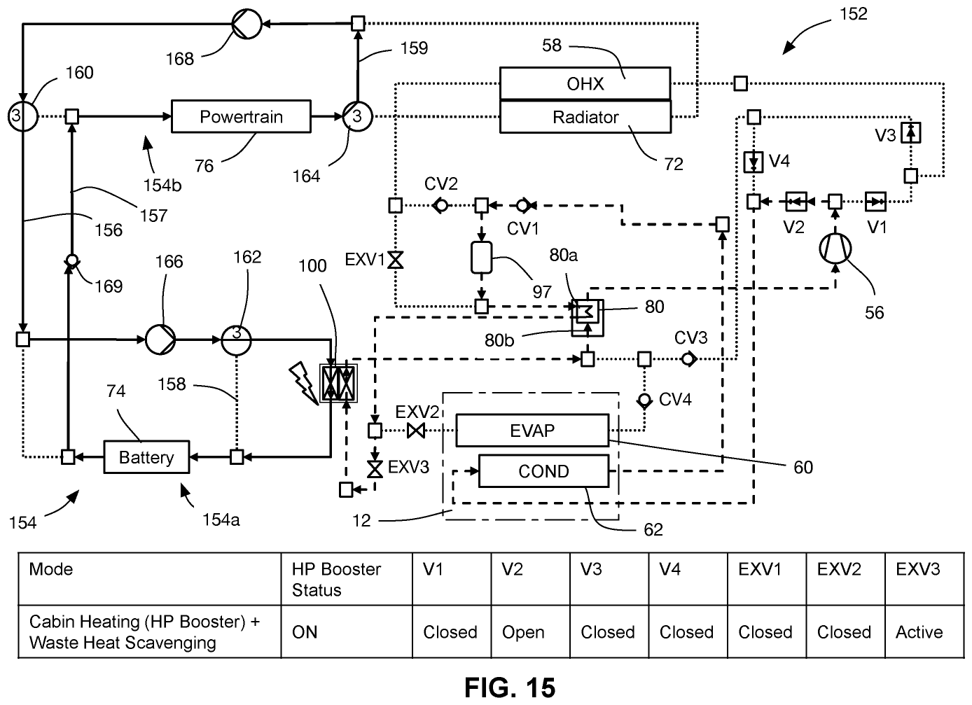

This mode is shown in FIG. 16. In this mode, the control valves V1, V2, V3 and V4 are all closed, and the expansion valves EXV1, EXV2 and EXV3 are all closed (off). The compressor 56 is off. The 3-way valves 160, 162 and 164 are positioned to isolate the battery loop 154a from the motor loop 154b. The battery loop pump 166 is on, so as to pump coolant 104 through the battery loop 154a. The motor loop pump 168 is not on. The secondary heater 122 is on.

This mode may be used on any day when the electric vehicle 151 is on plug, where the ambient air temperature is lower than a minimum acceptable operating temperature for the traction battery 74. (e.g. below 10 degrees Celsius). The electric vehicle 151 may not be occupied by anyone, and accordingly, there may not be a need to heat the passenger cabin, and therefore there may not be a need to run the refrigerant system. However, the control system 170 pre-heats the traction battery 74 so as to ensure that the traction battery 74 is heated to and kept at at least the minimum acceptable operating temperature. As a result, as soon as the driver of the electric vehicle enters the electric vehicle, the traction battery 74 is usable for transmitting power to the motor 76 without any negative impact on the battery due to the cold ambient air temperature. To carry out this pre-heating of the battery 74, the coolant 104 is circulated through the coolant-refrigerant heat exchanger 100 while the secondary heater 122 is on, so as to heat the coolant 104. The coolant 104 then circulates to, and heats, the traction battery 74.

It will be noted that the mode shown in FIG. 16 is another example of a secondary-heat-only mode for the coolant-refrigerant heat exchanger 100.

Description of Thermal Management System in Battery Heating and Cabin Heating Mode with Secondary Heater

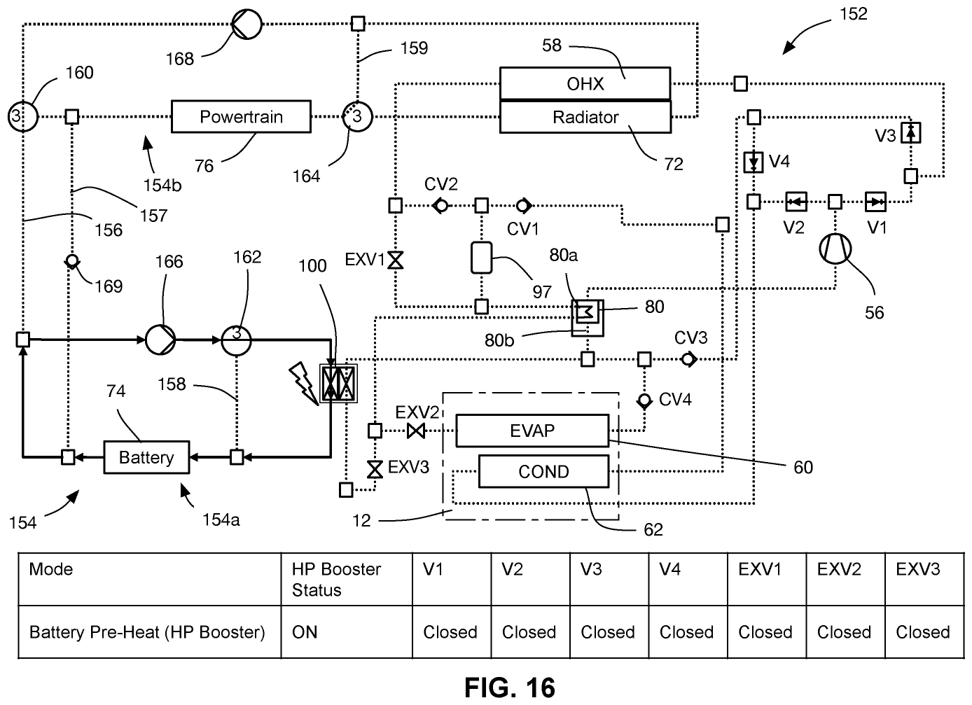

This mode is shown in FIG. 17. In this mode, the control valve V2 is open, and the control valves V1, V3 and V4 are all closed, and the expansion valve EXV2 is open, and the expansion valves EXV1 and EXV2 are closed (off). The 3-way valve 160 is positioned to isolate the battery loop 154a from the motor loop 154b. The battery loop pump 166 is on, so as to pump coolant 104 through the battery loop 154a. The motor loop pump 168 is also on, so as to pump coolant 104 through the motor loop 154b. The 3-way valve 162 is positioned to permit coolant flow through the coolant-refrigerant heat exchanger 100, and the 3-way valve 162 is positioned to cause the coolant flow in the motor loop 154b to bypass the radiator 72.

In this mode, the refrigerant 108 is directed from the compressor 56, through the control valve V2, through the interior condenser 62, through the check valve CV1, through the rrhe 80, through the expansion valve EXV3, through the coolant-refrigerant heat exchanger 100, back through the rrhe 80, and back to the compressor 56, in similar manner to the operation of the refrigerant system 152 in the mode shown in FIG. 13.

This mode may be used upon startup of the electric vehicle 151 on a very cold day (e.g. less than −15 degrees Celsius), thereby rendering unsuitable the use of the outside heat exchanger 58, and where the traction battery 74 is at the ambient air temperature. The refrigerant system 152 may be operated as was discussed in relation to FIG. 13. The coolant system 154 may be operated as was done in relation to FIG. 15. The secondary heater 122 is on.

It will be noted that the mode shown in FIG. 17 is another example of a secondary-heat-only mode for the coolant-refrigerant heat exchanger 100.

This mode shows that the secondary heater 122 may be used to heat both the refrigerant and the coolant at the same time.

Description of Thermal Management System in Cabin Heating Mode with Outside Heat Exchanger

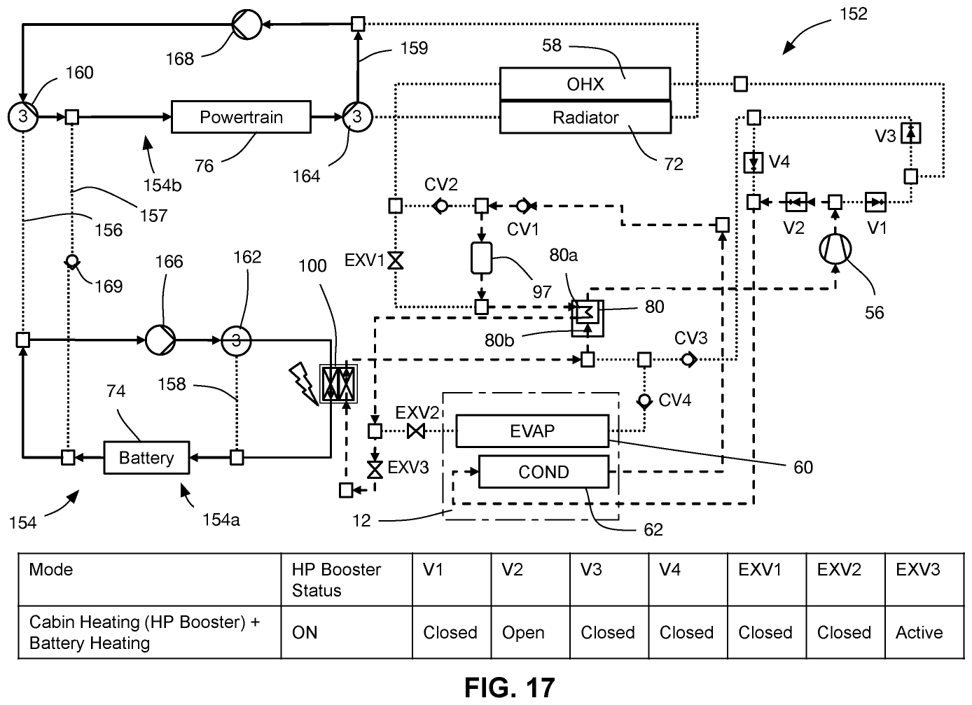

This mode is shown in FIG. 18. In this mode, the control valves V2 and V3 are open and the control valves V1 and V4 are closed. The expansion valve EXV1 is active (on) and the expansion valves EXV2 and EXV3 are closed (off). The secondary heater 122 is off.

In this mode, the refrigerant 108 is directed from the compressor 56, through the control valve V2, through the interior condenser 62, through the check valve CV1, through the expansion valve EXV1, through the outside heat exchanger 58, through control valve V3, through check valve CV3, through the rrhe 80, and back to the compressor 56.

This mode may be used when ambient temperatures outside the electric vehicle 151 are in the range of about −7 degrees Celsius to about 20 degrees Celsius, which permits the outside heat exchanger 58 to be used to scavenge heat from the outside air 22. The secondary heater 122 is not needed to be on in this mode.

Description of Thermal Management System in Cabin Heating and Defogging Mode with the Secondary Heater and with the Outside Heat Exchanger

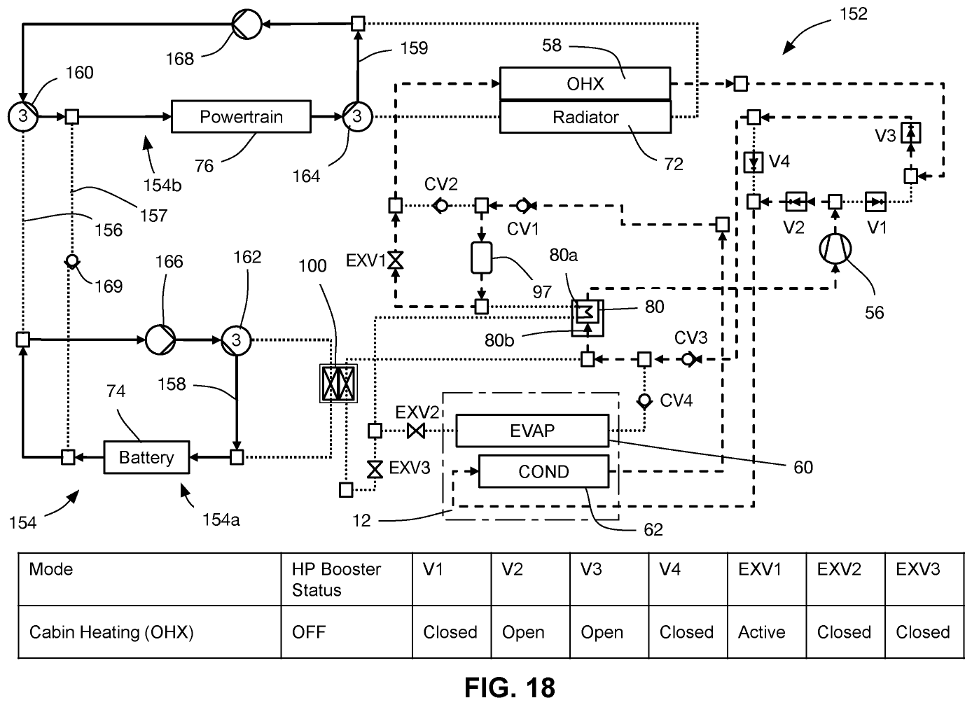

This mode is shown in FIG. 19. In this mode, the control valves V2 and V3 are open and the control valves V1 and V4 are closed. The expansion valves EXV1 and EXV2 are active (on) and the expansion valve EXV3 is closed (off). The secondary heater 122 is off.

This mode is similar to the mode shown in FIG. 18 except that the interior evaporator 60 is also operated in order to defog the windshield of the passenger cabin 12. In this mode, the refrigerant 108 is directed from the compressor 56, through the control valve V2, through the interior condenser 62, and through the check valve CV1. A first portion of the refrigerant flow passes through the expansion valve EXV1, through the outside heat exchanger 58, through control valve V3, through check valve CV3, through the rrhe 80, and back to the compressor 56. A second portion of the refrigerant flow passes through the rrhe 80, through the expansion valve EXV2, through the interior evaporator 60, through the check valve CV4, back through the rrhe 80, and back to the compressor 56.

This mode may be used when ambient temperatures outside the electric vehicle 151 are in the range of about −7 degrees Celsius to about 20 degrees Celsius, and when the interior air is humid such that defogging is requested by the vehicle occupants.

In the modes in FIGS. 18 and 19, the coolant-refrigerant heat exchanger 100 is not active and so the coolant system 154 may be operated in any suitable way. In the particular embodiments shown in FIGS. 18 and 19, the 3-way valve 160 keeps the battery loop 154a and the motor loop 154b isolated from one another and the 3-way valves 162 and 164 drive coolant flow though the bypass lines 158 and 159 respectively.

### Descriptions of Various Non-Heating, or Cooling Modes

### Description of Thermal Management System in Cabin Cooling Mode

This mode is shown in FIG. 20. In this mode, the control valve V1 is open and the control valves V2, V3 and V4 are closed. The expansion valve EXV2 is active (on) and the expansion valves EXV1 and EXV3 are closed (off). The secondary heater 122 is off.

In this mode, the interior evaporator 60 is used for cooling the passenger cabin 12. This mode may be used whenever cabin cooling is requested by the vehicle occupants. In this mode, the refrigerant 108 is directed from the compressor 56, through the control valve V1, through the outside heat exchanger 58, through the check valve CV2, through the rrhe 80, through the expansion valve EXV2, through the interior evaporator 60, through the check valve CV4, back through the rrhe 80, and back to the compressor 56.

The secondary heater 122 is off in this mode. The coolant system 154 may be operated in any suitable way. In the example shown, the 3-way valve 160 is positioned to keep the battery loop 154a and the motor loop 154b isolated from one another. The 3-way valve 162 is positioned to drive coolant through the battery loop bypass line 158. The 3-way valve 164 is positioned to drive coolant through the radiator 72.

### Description of Thermal Management System in Cabin Cooling and Battery Chilling Mode

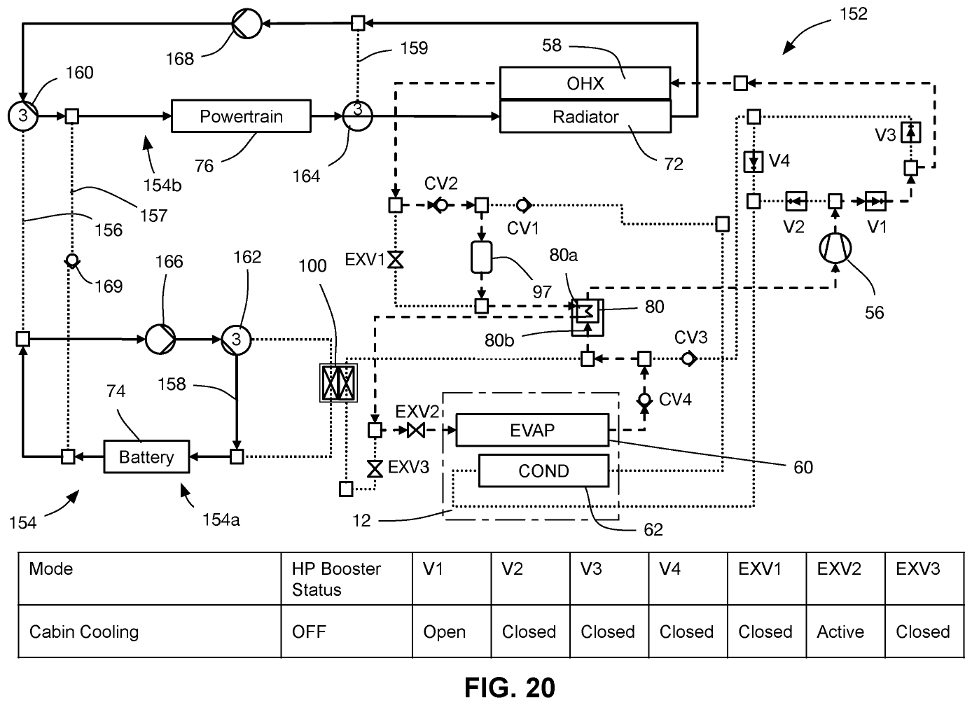

This mode is shown in FIG. 21. In this mode, the control valve V1 is open and the control valves V2, V3 and V4 are closed. The expansion valves EXV2 and EXV3 are active (on) and the expansion valve EXV1 is closed (off). The secondary heater 122 is off.

In this mode, the interior evaporator 60 is used for cooling the passenger cabin 12, and additionally, the coolant-refrigerant heat exchanger 100 is used to assist in cooling the traction battery 74. This mode may be used whenever cabin cooling is requested by the vehicle occupants, and the traction battery 74 has reached a temperature at which it requires cooling. In this mode, the refrigerant 108 is directed from the compressor 56, through the control valve V1, through the outside heat exchanger 58, through the check valve CV2, and through the rrhe 80. A first portion of the refrigerant flow passes through the expansion valve EXV2, through the interior evaporator 60, through the check valve CV4, back through the rrhe 80, and back to the compressor 56. A second portion of the refrigerant flow passes through the expansion valve EXV3, through the coolant-refrigerant heat exchanger 100, back through the rrhe 80, and back to the compressor 56.

The coolant system 154 may be operated such that the 3-way valve 160 is positioned to keep the battery loop 154a and the motor loop 154b isolated from one another. The 3-way valve 162 is positioned to drive coolant through the coolant-refrigerant heat exchanger 100 so as to be cooled by the refrigerant flow therethrough. The 3-way valve 164 may be positioned to drive coolant through the radiator 72.

### Description of Thermal Management System in Battery Chilling Mode

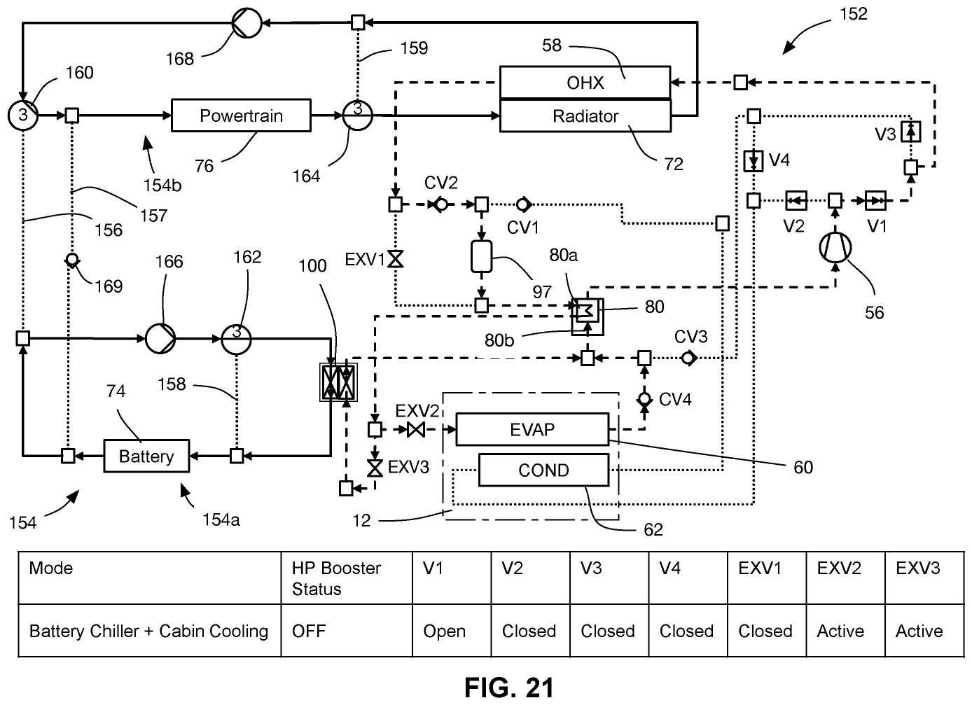

This mode is shown in FIG. 22. In this mode, the control valve V1 is open and the control valves V2, V3 and V4 are closed. The expansion valve EXV3 is active (on) and the expansion valves EXV1 and EXV2 are closed (off). The secondary heater 122 is off.

In this mode, the coolant-refrigerant heat exchanger 100 is used to assist in cooling the traction battery 74. This mode may be used whenever the traction battery 74 has reached a temperature at which it requires cooling. In this mode, the refrigerant 108 is directed from the compressor 56, through the control valve V1, through the outside heat exchanger 58, through the check valve CV2, through the rrhe 80, through the expansion valve EXV3, through the coolant-refrigerant heat exchanger 100, back through the rrhe 80, and back to the compressor 56.

The coolant system 154 may be operated such that the 3-way valve 160 is positioned to keep the battery loop 154a and the motor loop 154b isolated from one another. The 3-way valve 162 is positioned to drive coolant through the coolant-refrigerant heat exchanger 100 so as to be cooled by the refrigerant flow therethrough. The 3-way valve 164 may be positioned to drive coolant through the radiator 72.

### Discussion of Sequences of Modes-Reducing Ice Buildup on Outside Heat Exchanger

In some instances, the thermal management system 150 may be operated in a way that takes advantage of the presence of the coolant-refrigerant heat exchanger 100 but also operates the outside heat exchanger 58 for periods of time in order to take advantage of the energy efficiency of doing so. Thus, the thermal management system 150 may be operated in the mode shown in any of FIG. 18, 19 or 14 (i.e. a mode in which the outside heat exchanger 58 is operated as an evaporator) for a first period of time. At a suitable time, the control system 170 shifts operation of the thermal management system 150 to the mode shown in FIG. 13 (or in general to a mode where the coolant-refrigerant heat exchanger 100 is used as an evaporator and the secondary heater 122 is on, and stops use of the outside heat exchanger 58 in order to give it time for any ice built up thereon to melt. Worded differently, it may be said that the control system 170 may select to switch from a first mode using the outside heat exchanger 58 as an evaporator (optionally in parallel with using the coolant-refrigerant heat exchanger 100), to a second mode in which the control system 170 uses the coolant-refrigerant heat exchanger 100 as an evaporator and stops using the outside heat exchanger 58.

Optionally, at a second suitable time, the control system 170 may start using the outside heat exchanger 58 again as an evaporator, again either alone or in parallel with using the coolant-refrigerant heat exchanger 100 as an evaporator.

The control system 170 may shift operation to the mode of FIG. 13 (the second mode) and/or to a mode in which the outside heat exchanger 58 is used as an evaporator (the first mode) based on one or more suitable criteria. For example, the control system 170 may be equipped with a clock and may shift operation between the first mode and the second mode based on the amount of elapsed time that has taken place. In other words, the control system 170 may operate in the first mode for a first selected period of time and may switch to the second mode based on the assumption that operation in the first mode has gone on for sufficiently long that there is a certain amount of risk of icing of the outside heat exchanger 58. Similarly, the control system 170 may operate in the second mode for a second selected period of time and may switch back to the first mode based on the assumption that a sufficient amount of time has passed for any ice buildup on the outside heat exchanger 58 to have melted.

Alternatively, the control system 170 may be equipped to receive signals from a suitable pressure sensor that detects the pressure of the refrigerant 108 downstream from the outside heat exchanger 58. Thus, when operating in the first mode, if the sensed pressure is below a selected low pressure threshold, the control system 170 may switch the thermal management system 150 to the second mode based on the assumption that the low pressure is the result of poor performance of the outside heat exchanger 58 in evaporating the refrigerant 108, as a result of ice buildup on the outside heat exchanger 58.

While the thermal management system 150 has been shown in FIGS. 13-22 to include such elements as an interior evaporator, it will be understood that in certain embodiments, the interior evaporator may be omitted.

While the thermal management system 150 has been described in relation to the electric vehicle 151, it is alternatively possible to employ the coolant-refrigerant heat exchanger 100 in a stationary application, such as where electricity is generated, stored and/or consumed at a residence, or in a commercial or industrial building.

While the description contained herein constitutes a plurality of embodiments of the present invention, it will be appreciated that the present invention is susceptible to further modification and change without departing from the fair meaning of the accompanying claims.

LIST OF ITEMS

| Reference | | |
|---|---|---|
| Number | Name | FIG. |
| 10 | Vehicular air conditioning system | 1 |
| 12 | Passenger cabin | 1, 3-5, 13-22 |
| 14 | Compressor | 1 |
| 16 | Condenser | 1 |
| 18 | Expansion valve | 1 |
| 20 | Evaporator | 1 |
| 22 | Outside air | 1 |
| 24 | Inside air | 1 |
| 26 | Outside fan | 1 |
| 28 | Inside fan | 1 |
| 30 | Curve | 2 |
| 30a | Curve segment | 2 |
| 30b | Curve segment | 2 |
| 30c | Curve segment | 2 |
| 30d | Curve segment | 2 |
| 32 | Point | 2 |
| 34 | Point | 2 |
| 36 | Point | 2 |
| 38 | Point | 2 |
| 40 | Heat pump system | 3, 4 |
| 42 | Outside heat exchanger | 3, 4 |
| 44 | Inside heat exchanger | 3, 4 |
| 46 | Reversing valve | 3, 4 |
| 50 | Thermal management system | 5 |
| 52 | Refrigerant system | 5 |
| 54 | Coolant system | 5 |
| 56 | Compressor | 5, 13-22 |
| 58 | Outside heat exchanger | 5, 13-22 |
| 60 | Interior evaporator | 5, 13-22 |
| 62 | Interior condenser | 5, 13-22 |
| 64 | First pump | 5 |
| 66 | Second pump | 5 |
| 68a | Control valve | 5 |
| 68b | Control valve | 5 |
| 70 | Check valve | 5 |
| 72 | Radiator | 5, 13-22 |
| 74 | Traction battery | 5, 13-22 |
| 76 | Traction motor | 5, 13-22 |
| 78 | Coolant-refrigerant heat exchanger | 5 |
| 78a | Coolant flow path | 5 |
| 78b | Refrigerant flow path | 5 |
| 80 | Refrigerant-refrigerant heat exchanger | 5, 13-22 |
| 97 | Receiver/dryer | 5, 13-22 |
| 99 | Wheels | 23 |
| 100 | Coolant-refrigerant heat exchanger | 6, 13-22 |
| 102 | Coolant flow path | 10, 11, 12 |
| 104 | Coolant | 10, 11, 12 |
| 106 | Refrigerant flow path | 10, 11, 12 |
| 108 | Refrigerant | 10, 11, 12 |
| 109 | First end cover plate | 7a, 9, 10 |
| 110 | Flow plate | 7a, 7b, 8, 9, 10 |
| 110a | First flow plate | 7a, 9, 10 |
| 110b | Second flow plate | 7a, 9, 10 |
| 110c | Third flow plate | 7a, 9, 10 |
| 110d | Fourth flow plate | 7a, 9, 10 |
| 110e | Fifth flow plate | 7a, 9, 10 |
| 110f | Sixth flow plate | 7a, 9 |
| 111 | Second end cover plate | 7b, 9 |
| 112a | First face | 7b |
| 112b | Second face | 7b |
| 113 | Refrigerant passthrough aperture | 7b, 8, 9 |
| 114 | Peripheral edge | 7b |
| 115 | Coolant pass-through aperture | 7b, 8, 9 |
| 116a | Refrigerant inlet | 6, 7a, 9, 10 |
| 116b | Refrigerant outlet | 6, 7a, 8, 9, 10 |
| 118a | Coolant inlet | 6, 7a, 8, 9, 10 |
| 118b | Coolant outlet | 6, 7a, 9, 10 |
| 119 | Refrigerant filter | 7a |
| 120 | Ridge | 7b, 8, 10 |
| 121 | Coolant space | 9, 11, 12 |
| 122 | Secondary heater | 7b |
| 122a | Band | 7b, 8, 9 |
| 122b | First end heater plate | 7a |
| 122c | Second end heater plate | 7b |
| 123 | Refrigerant space | 9, 11, 12 |
| 124 | Controller | 7a, 8 |
| 125 | Heat spreader plate | 7b |
| 126 | Electrical connection | 6, 7a |
| 128 | Electrical connection | 6, 7a |
| 130 | Heat exchanger housing | 6 |
| 130a | First housing portion | 7b, 8, 9 |
| 130b | Second housing portion | 7a, 9 |
| 132 | O-ring | 7a, 9 |
| 134 | Aperture | 6, 7a |
| 136 | Seal member | 7a |
| 150 | Thermal management system | 13-22 |
| 151 | Electric vehicle | 23 |
| 152 | Refrigerant system | 13-22 |
| 154 | Coolant system | 13-22 |
| 154a | Battery loop | 13-22 |
| 154b | Motor loop | 13-22 |
| 156 | First transfer conduit | 13-22 |
| 157 | Second transfer conduit | 13-22 |
| 158 | Battery loop bypass conduit | 13-22 |
| 159 | Motor loop bypass conduit | 13-22 |
| 160 | First 3-way valve | 13-22 |
| 162 | Second 3-way valve | 13-22 |
| 164 | Third 3-way valve | 13-22 |
| 166 | Battery loop pump | 13-22 |
| 168 | Motor loop pump | 13-22 |
| 170 | Control system | 13 |
| 170a | PCB | 13 |
| 170b | Processor | 13 |
| 170c | Memory | 13 |
| 172 | Cabin temperature sensor | 13 |
| 174 | Refrigerant temperature sensor | 13 |
| 176 | Secondary heater temperature sensor | 13 |
| 180 | Curve | 24 |
| 180a | Curve segment | 24 |
| 180b | Curve segment | 24 |
| 180c | Curve segment | 24 |
| 180d | Curve segment | 24 |
| 182 | Point | 24 |
| 184 | Point | 24 |
| 186 | Point | 24 |
| 188 | Point | 24 |
| 190 | Boundary line | 24 |
| 190a | Curve segment | 24 |
| 190b | Curve segment | 24 |
| 190c | Curve segment | 24 |
| 190d | Curve segment | 24 |
| 192 | Point | 24 |
| 194 | Point | 24 |
| 196 | Point | 24 |
| 198 | Point | 24 |
| 199 | Curve segment | 24 |
| 200 | Method | 25 |
| 202 | Method step | 25 |
| 204 | Method step | 25 |
| 206 | Method step | 25 |
| 208 | Method step | 25 |
| 210 | Method step | 25 |
| 212 | Method step | 25 |
| 214 | Method step | 25 |
| 220 | Method | 26 |
| 222 | Method step | 26 |
| 224 | Method step | 26 |
| 230 | Flange portion | 27 |
| 240 | Outermost edge | 27 |
| 242 | Heat exchange surface | 28 |

1. A thermal management system for an electric vehicle, comprising:
a refrigerant system including a compressor, an interior condenser, an outside heat exchanger, and an expansion valve;
a coolant system including a pump, and a radiator;
a plurality of thermal loads including a traction motor, and an energy source;
a coolant-refrigerant heat exchanger that includes
a coolant flow path for transporting coolant therethrough,
a refrigerant flow path for transporting refrigerant therethrough, wherein the coolant flow path and the refrigerant flow path are positioned in order to transfer heat from one of the coolant and the refrigerant to the other of the coolant and the refrigerant, and
a secondary heater that is positioned to heat both the refrigerant and the coolant in the coolant-refrigerant heat exchanger,
wherein the expansion valve is upstream from the coolant-refrigerant heat exchanger, and wherein the secondary heater is sized to evaporate all of the refrigerant passing through the refrigerant flow path,
a control system that is operatively connected to the coolant-refrigerant heat exchanger, and is programmed to:
operate the coolant-refrigerant heat exchanger in a secondary-heat-only mode in which the secondary heater evaporates the refrigerant in the refrigerant flow path without any heat input from the coolant in the coolant flow path, and
to operate the coolant-refrigerant heat exchanger in a heat-scavenging mode in which at least some heat from the coolant in the coolant flow path evaporates the refrigerant in the refrigerant flow path.

2. The thermal management system as claimed in claim 1, wherein in the heat-scavenging mode the coolant in the coolant flow path and the secondary heater together evaporate the refrigerant in the refrigerant flow path.

3. The thermal management system as claimed in claim 1, wherein, in the secondary-heat-only mode, the secondary heater heats the coolant in the coolant flow path.

4. The thermal management system as claimed in claim 1, wherein the secondary heater is an electric heater.

5. The thermal management system as claimed in claim 1, wherein the coolant-refrigerant heat exchanger includes a plurality of flow plates each having a plurality of faces and a peripheral edge, wherein the plurality of flow plates are sealingly joined together such that the coolant flow path and the refrigerant flow path are positioned between mutually facing ones of the faces of adjacent ones of the plurality of flow plates, and the secondary heater extends along the peripheral edge of each of the plurality of flow plates.

6. The thermal management system as claimed in claim 1, wherein the plurality of flow plates are aluminum.

7. The thermal management system as claimed in claim 1, wherein the energy source is a traction battery that is connected to the traction motor to provide electrical power to the traction motor.

8. The thermal management system as claimed in claim 1, wherein the control system is programmed to:
operate the thermal management system in an outside heat exchanger mode in which refrigerant is evaporated in the outside heat exchanger and not in the coolant-refrigerant heat exchanger.

9. A coolant-refrigerant heat exchanger for a thermal management system for an electric vehicle, comprising:
a coolant flow path for transporting coolant therethrough,
a refrigerant flow path for transporting refrigerant therethrough, wherein the coolant flow path and the refrigerant flow path are positioned in order to transfer heat from one of the coolant and the refrigerant to the other of the coolant and the refrigerant, and
a secondary heater that is positioned to heat both the refrigerant and the coolant in the coolant-refrigerant heat exchanger,
wherein the expansion valve is upstream from the coolant-refrigerant heat exchanger,
wherein the coolant-refrigerant heat exchanger includes a plurality of flow plates each having a plurality of faces and a peripheral edge, wherein the plurality of flow plates are sealingly joined together such that the coolant flow path and the refrigerant flow path are positioned between mutually facing ones of the faces of adjacent ones of the plurality of flow plates, and the secondary heater extends along the peripheral edge of each of the plurality of flow plates.

10. The coolant-refrigerant heat exchanger as claimed in claim 9, wherein the flow plates are aluminum.

11. The coolant-refrigerant heat exchanger as claimed in claim 9, wherein the secondary heater further includes a first end heater that is positioned to heat a first end of the plurality of flow plates through a thickness of the flow plates.

12. The thermal management system as claimed in claim 11, wherein the secondary heater further includes a second end heater that is positioned to heat a second end of the plurality of flow plates through the thickness of the flow plates.

13. A method of operating a refrigerant system in an electric vehicle, comprising:
a) compressing a refrigerant in the refrigerant system, thereby bringing the refrigerant from a first temperature and a first pressure to a second temperature and a second pressure, wherein the first temperature is sufficiently low that the first pressure is less than 1 atmosphere;
b) condensing the refrigerant after step a), thereby bringing the refrigerant from the second temperature and the second pressure to a third temperature and a third pressure;
c) passing the refrigerant through an expansion valve after step b), thereby bringing the refrigerant from the third temperature and the third pressure to a fourth temperature and a fourth pressure;
d) evaporating the refrigerant after step c), in an evaporator that is a coolant-refrigerant heat exchanger, and having a secondary heater, wherein the coolant-refrigerant heat exchanger is positioned to transfer heat between a coolant in a coolant system of the electric vehicle and the refrigerant, wherein the evaporating is carried out by heating the refrigerant using the secondary heater and without heating the refrigerant using the coolant-refrigerant heat exchanger, to bring the refrigerant from the fourth temperature and the fourth pressure to a fifth temperature and a fifth pressure, wherein the fifth temperature is sufficiently high that the fifth pressure is greater than 1 atmosphere; and
e) compressing the refrigerant after step d), thereby bringing the refrigerant from the fifth temperature and the fifth pressure to beyond the fifth temperature and beyond the fifth pressure.

14. The method as claimed in claim 13, wherein step b) includes:
f) passing an airflow across a condenser, wherein the condenser contains the refrigerant, thereby heating the airflow; and
g) transporting the airflow into a cabin of the electric vehicle to heat the cabin.
